(19) United States
(12) Patent Application Publication
(10) Pub. No.: US 2002/0103705 A1
(43) Pub. Date: Aug. 1, 2002

(54) Method and apparatus for using prior purchases to select activities to present to a customer

(75) Inventor: James T. Brady, San Jose, CA (US)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: Forecourt Communication Group

(21) Appl. No.: 10/012,253

(22) Filed: Dec. 5, 2001

Related U.S. Application Data
(60) Provisional application No. 60/251,933, filed on Dec. 6, 2000.

(51) Int. Cl. G06F 17/60; G06G 1/12

(52) U.S. Cl. 705/14; 705/21

(57) ABSTRACT

Apparatus, and a corresponding method, present to a consumer various forms of information (information, ads, offers to sell . . . ) during periods where the consumer is idle, where the forms of information are based on the consumer's prior purchases. The system being comprised of one or more user terminals that present activities to the user, and one or more servers that collect, store and disseminate the information used in this process. A first server monitors the purchases of the user and transmits these to a second server, which consolidates the data into the user database. The second server correlates the user database containing the prior purchases and an activity database, to provide the correlation between the products and the activities, and disperses the correlation data to the appropriate first servers. The activities are then selected by the first server based on a correlation to prior purchases of the user, when the user subsequently uses one of the terminals.

### FIELD OF THE INVENTION

This invention relates to a method of selecting one or more activities to be presented, based on historical information concerning prior purchases that the customer has made, such that the customers probability of completing the activity with a favorable outcome is increased.

### BACKGROUND OF THE INVENTION

This invention relates generally to point-of-service computer systems of the type used in multilane retail stores, gas stations and banks to record transactions. Specifically, the invention relates to point-of-service systems that can handle the presentation of visual or audio information to the customer and allow that customer to respond to that information. Point-of-service systems have mechanisms for inputting a code recorded on a credit card, debit card, loyalty card, drivers license, and/or acquiring via some other means the identification of a customer being serviced. Such mechanisms include magnetic track readers (commonly called ‘stripe readers’), keypads, and touch screens.

During the final minutes of a purchase of products in a retail environment, the customer is faced with a period of idle time. In a multilane store (grocery, variety goods . . . ), the customer waits for the checkout clerk to ring up the various purchases. In a gas station, the customer waits for the attendant or pump to fill the tank. This is wasted time. In general, neither the customer nor the store benefits from the activities of the customer during this time.

A mechanism for making use of this time can allow the retailer to gain additional revenue and profit. This invention allows these objectives to be met by providing the selection of activities that the customer can perform during this time such that the activities are likely to be ones the customer would select a favorable outcome. An example would be an activity that offered the customer a discount coupon for a diet soda. If the customer selected the option to print the coupon, it would be a favorable outcome. If the offer were rejected, the time spent would be wasted and the outcome would be unfavorable.

### SUMMARY OF THE INVENTION

The method of the invention involves the collecting of information about the prior purchases of the customer, including their interactions with this system, in a specific venue, at a time of day, and date; building profiles regarding specific consumers and generic consumers; collecting information about a current retail transaction, and using that information in whole or in part to select activities for presentation to the customer. An optimization of this selection takes into effect the value of a proposed use of idle time to the presenting retailer, the utility to the customer, and the customer's previous purchases.

The activities presented to a customer may be information messages, advertisement, offers to sell, map directions, games, etc. These activities may be completed by the customer by rejecting the activity; choosing to print information, coupon, map or certificate; purchasing the item or service offered; playing the game; and otherwise engaging in a dialog with the activity.

A number of means are provided to: identify the customer; identify the venue; identify a start of idle time; present information; measure the time taken to present information; measure the time taken by the customer to respond to information; log customer purchases; and to construct dialogs leading to specific activities.

The invention performs the steps of collecting information from customer transactions at specific store locations in the form of product purchases; aggregating that information at a computer; analyzing the aggregated information to: extract the probability of habitual activities, and correlating one or more of said product purchases to one or more said activities by a correlation weight means which is indicative of customer completing the activity(s) with a favorable outcome. The activities with the highest correlation weight are added to a customer or store profile and subsequently used to select activities for presentation to customers. The activities in the profile need not be exclusively selected by this means, and may include activities selected by one or more other criterion.

The foregoing and still further objects and advantages of the present invention will be more apparent from the following detailed explanation of the preferred embodiments of the invention in connection with the accompanying drawings.

### BRIEF DESCRIPTION OF THE DRAWINGS

FIG. 1, Overview, is a diagram of the flow of information in the system implementing the invention.

FIG. 2 is a diagram of a computer System, which is adapted to perform the method of the invention.

FIG. 3 is a diagram of a computer sub-system called the Central Server.

FIG. 4 is a diagram of a computer sub-system called the Store Controller.

FIG. 5 is a diagram of a computer sub-system called the Store Server.

FIG. 6 is a diagram of a computer sub-system representative of a Point-of-Service Terminal.

FIG. 7 is a diagram of a Customer Interface.

FIG. 8 is a diagram of a tree structure that represents a Customer Idle Time Dialog.

FIG. 9 is a diagram of a tree structure that represents a Customer Activity Dialog.

FIG. 10 is a diagram of the Screen and its associated input areas.

FIG. 11 is a diagram that shows Store Setup and Update process.

FIG. 12 is a Customer Table that describes the characteristics of a customer.

FIG. 13 is a Customer Store Profile Table that describes a the customer in a specific store.

FIG. 14 is a Store Subset of the Customer Store Profile Table of FIG. 13, Customer Store Profile Table

FIG. 15 is a Credit, Debit, Loyalty . . . Cards Table that conects the customer with one or more ID cards.

FIG. 16 is a Store Definition Table that describes each store.

FIG. 17 is a Store Controller Message that communicates information from the Store Controller to the Store Server.

FIG. 18 describes a Screen Instrumentation Message.

FIG. 19 describes a Customer Selection Instrumentation Message.

FIG. 20 describes an Instrumentation Table.

FIG. 21 is the Customer Profile Generation Instrumentation Table.

FIG. 22 is a Point-of-service Terminal Table.

FIG. 23 describes a Store Profile Table.

FIG. 24 describes a Customer Session.

FIG. 25 is used for Time-of-day Conversion.

FIG. 26 describes the proposed Activities List.

FIG. 27 is the Activity Table.

FIG. 28 is a Screen Definition Table.

FIG. 29 is a Text Element Table.

FIG. 30 is a Graphic Element Table.

FIG. 31 is a Touch Element Table.

FIG. 32 is a Key Pad Element Table.

FIG. 33 is an Activity Work Table.

FIG. 34 is a Store Configuration Table.

FIG. 35 is a System Response Time Work Table.

FIG. 36 is an activity diagram that describes a Customer Session in a store.

FIG. 37 is an activity diagram that describes usage of Customer Idle Time.

FIG. 38 is an activity diagram that describes a Customer Activity Cycle.

FIG. 39 is an activity diagram that describes Customer Action Cycle.

FIG. 40 is a flow chart for Detecting Start & End of Idle Time.

FIG. 41 is a flow chart describing the Calculation of Expected Idle Time.

FIG. 42 is a flow chart describing the Selection of Proposed Activities.

FIG. 43 is a flow chart describing the Store Profile Table Generation

FIG. 44 is a Continuation of Store Profile Table Generation

FIG. 45 is a flow chart describing the Customer Session Table Generation

FIG. 46 is a flow chart describing the Customer Store Profile Table Generation

FIG. 47 is a Continuation of Customer Store Profile Table Generation

FIG. 48 is a flow chart describing the System Response Time Calculation

FIG. 49 is a flow chart describing Activity Selection

FIG. 50 is a Purchase and Activity Correlation Table

FIG. 51 is a Product Class Table

### DETAILED DESCRIPTION OF THE INVENTION

The invention is described in terms of a multilane store (that is, a store with multiple checkout counters), but applies to retail, wholesale, financial institutions, and venues having a terminal that interacts directly with a customer.

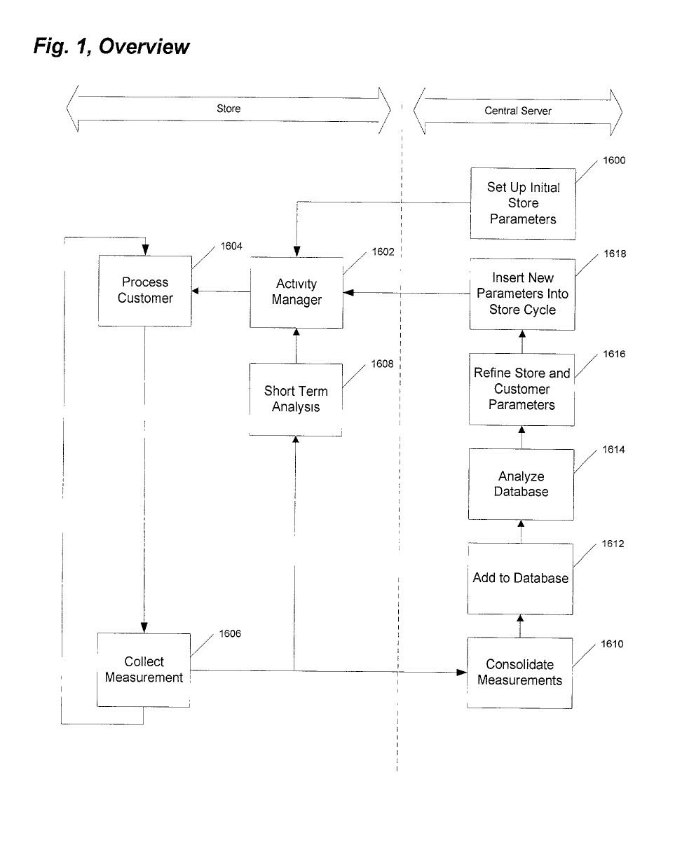

FIG. 1. Depicts the flow of information in the system. In a store, there is an established process for collecting payment from a customer. This is represented in Process Customer 1604. Prior to the installation of an implementation of this invention the process deals with ‘ringing up’ the prices of the items purchased, establishing the total price, and collecting payment for that total from the customer; then repeating the process with subsequent customers. This process is modified to present information to the customer during the times in the Process Customer 1604 that the customer is idle (normally this is while the purchases are being ‘rung up’). To affect this, Step 1604 is modified as shown subsequently, and Steps 1600, 1602, and 1606 through 1618 are added to the system.

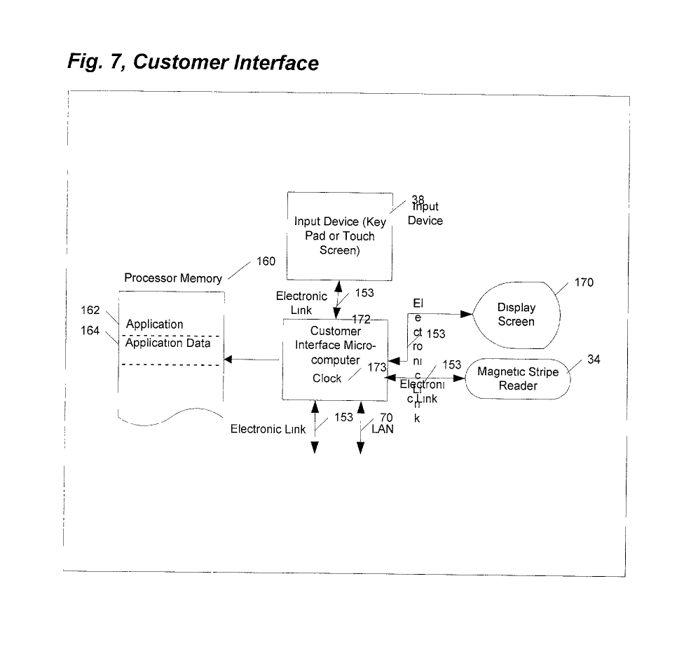

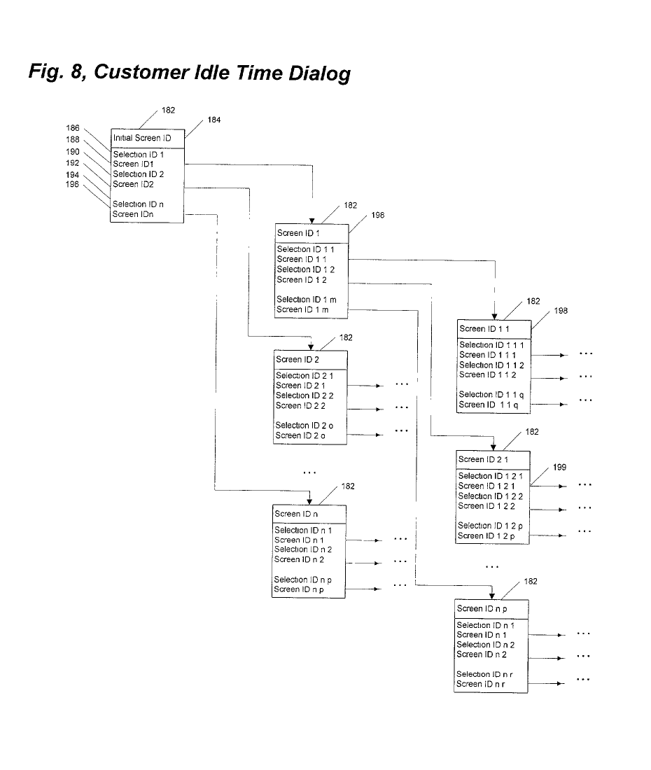

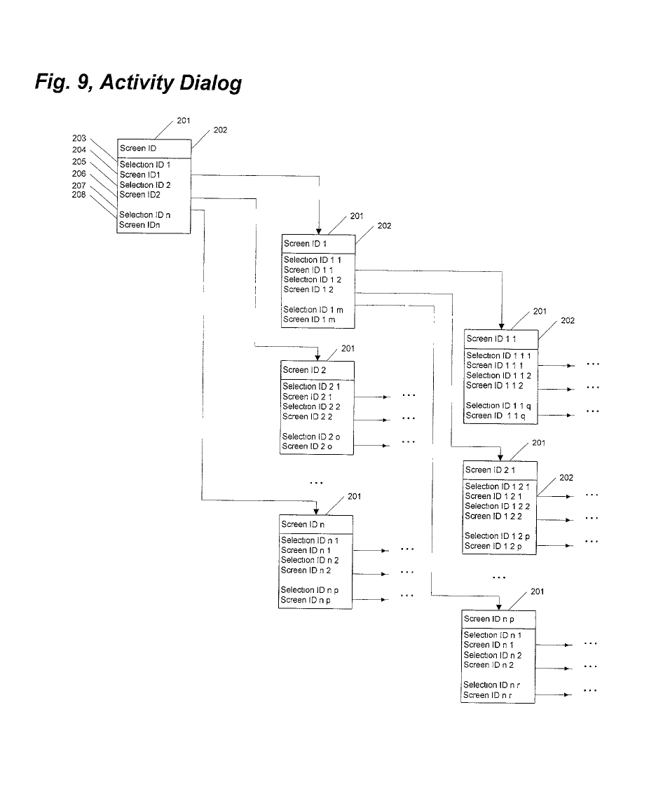

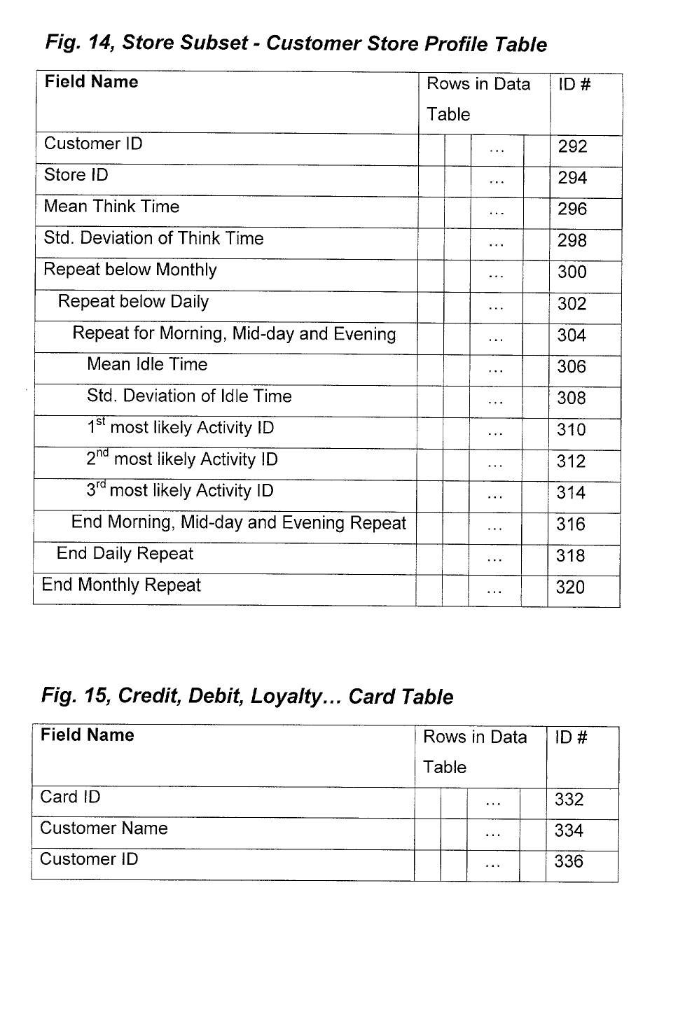

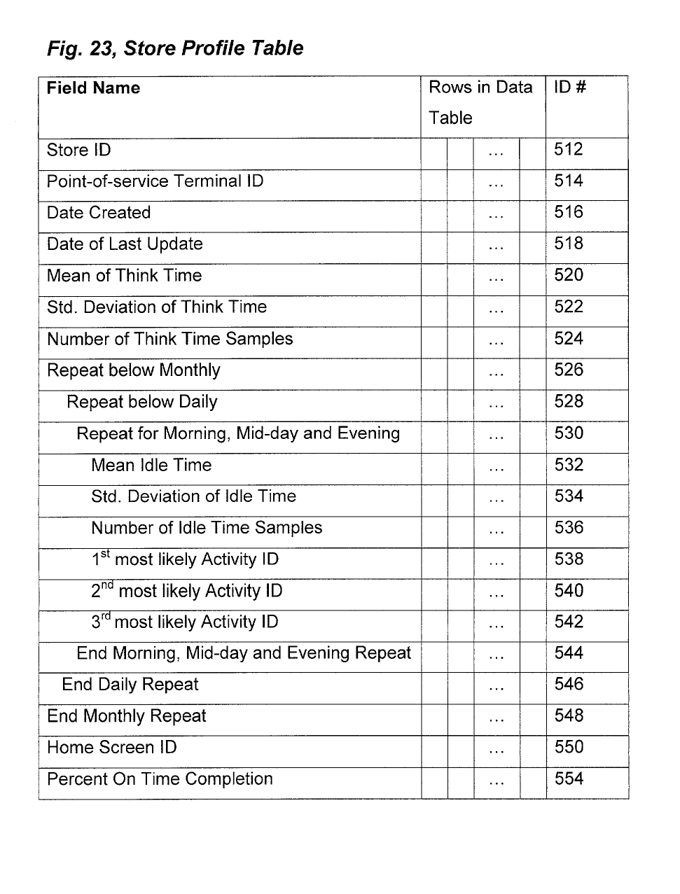

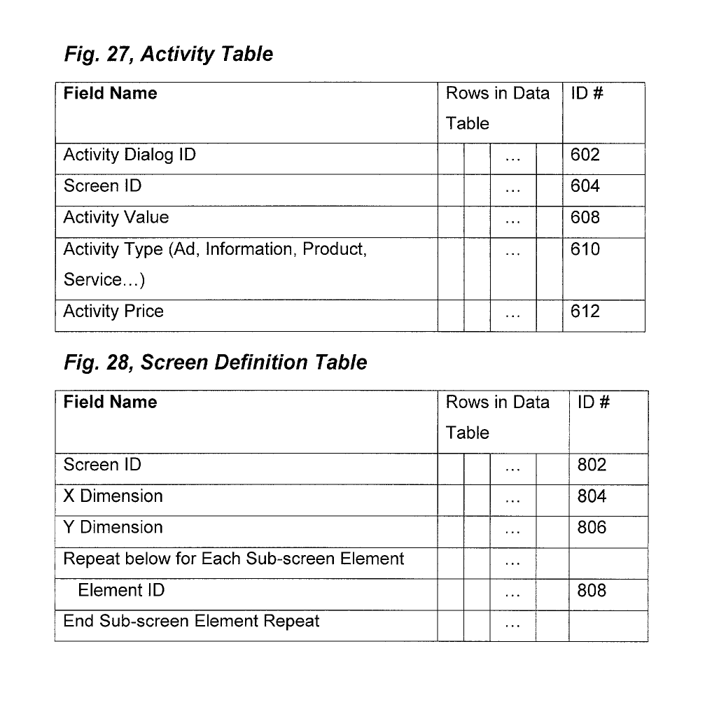

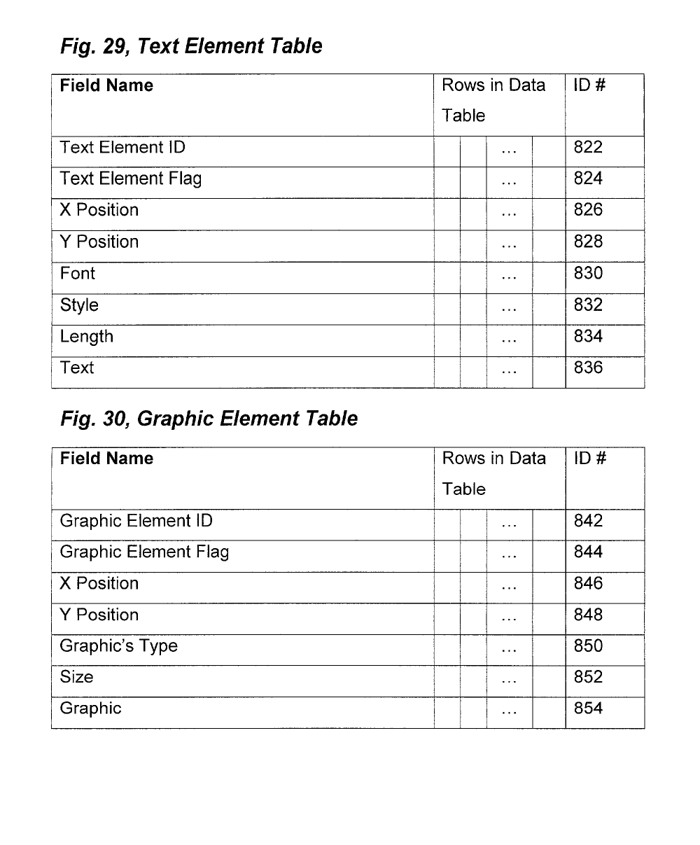

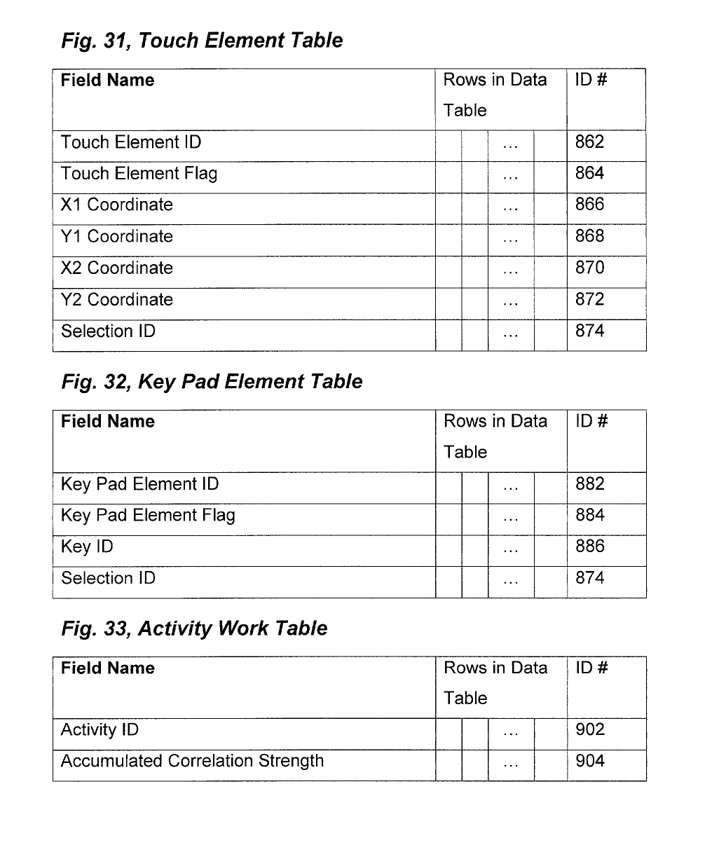

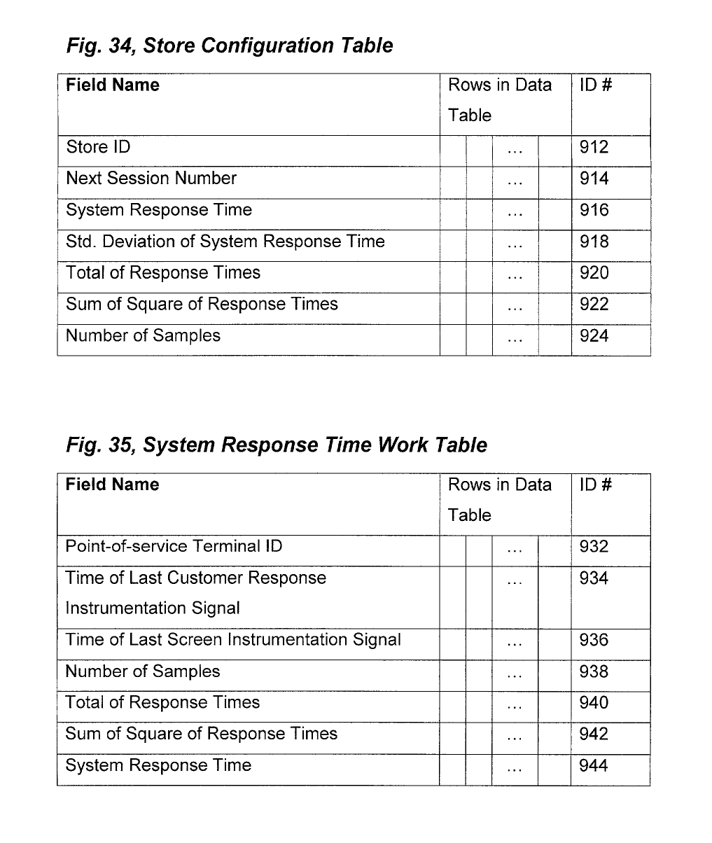

Once the store has been set up, Set Up Initial Store Parameters 1600, communicates to Activity Manager 1602, a set of default parameters including FIG. 23, Store Profile Table, FIG. 28, Screen Definition Table; FIG. 29, Text Element Table; FIG. 30, Graphic Element Table; FIG. 31, Touch Element Table; FIG. 32, Key Pad Element Table; FIG. 34, Store Configuration Table; FIG. 9, Activity Dialogs; FIG. 14, Store Subset—Customer Store Profile Table; and FIG. 27, Activity Table. Process Customer 1604 prompts Activity Manager 1602 with a Customer ID supplied by the FIG. 7, Customer Interface. The Activity Manager 1602, using the available data, constructs, as depicted in FIG. 42, entitled Selection of Proposed Activities, FIG. 26, Proposed Activity List. Those activities are transformed into a FIG. 8, Customer Idle Time Dialog by using the Expected Idle Time 570, which is depicted in FIG. 41, Calculation of Expected Idle Time. The result is passed to FIG. 42, Selection of Proposed Activities. Next, FIG. 42 is effected which generates FIG. 26, Proposed Activity List with an excess of activities, which are then pruned to fit Expected Idle Time 570 within the Percent On Time Completion 554 criteria. Then, referencing back to FIG. 1, Activity Manager 1602 generates FIG. 8, Customer Idle Time Dialog from FIG. 26, Proposed Activity List.

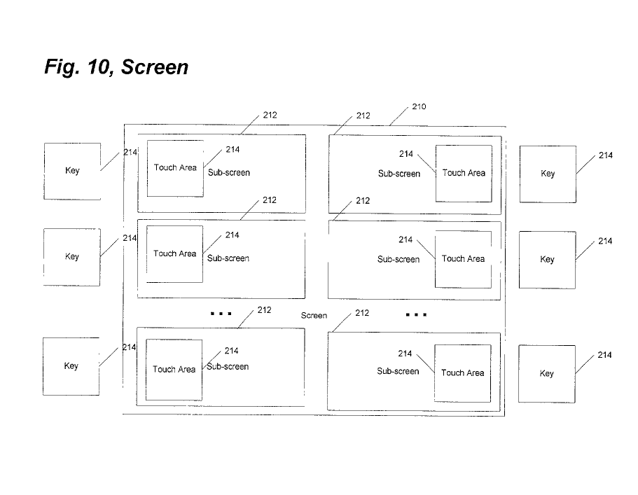

Process Customer 1604 uses the FIG. 8, Customer Idle Time Dialog to control the presentation of various FIG. 10, Screens, to the customer.

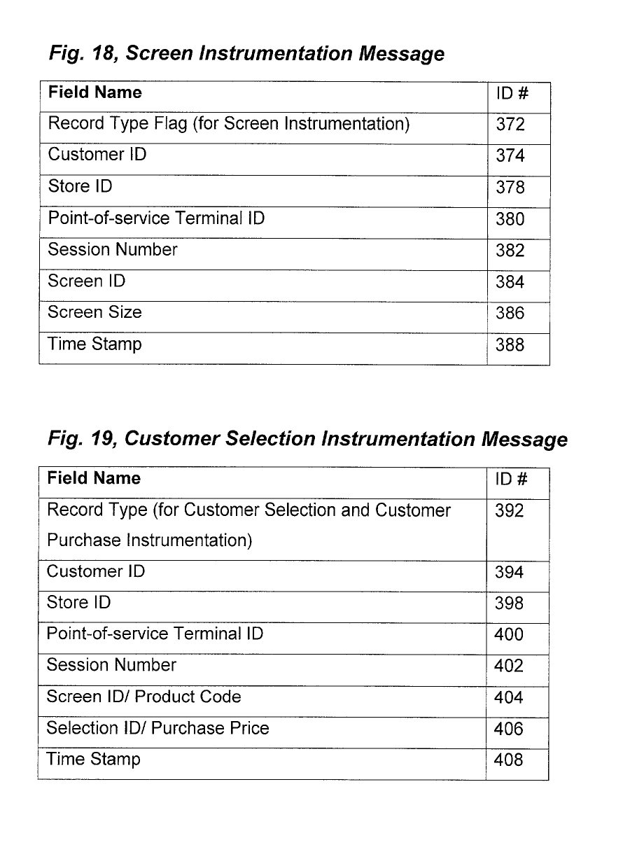

As FIG. 10, Screens are presented and responded to; FIG. 18, Screen Instrumentation Messages and FIG. 19, Customer Selection Instrumentation Messages are generated. These are transmitted to Collect Messages 1606 for transmission to Short Term Analysis 1608 and Consolidate Measurements 1610. Short Term Analysis 1608 uses the information to update FIG. 34, Store Configuration Table. This information is used to refine the ability of the Activity Manager 1602 to estimate System Response Time 916 and Std. Deviation of System Response Time 918.

A further function of Collect Measurements 1606 is the logging of the purchases made by the customer during the transaction. These are transmitted to Consolidate Measurements 1610. Consolidate Measurements 1610, pools the information for a period of time (say a month) adding it to a database of measurements (Add to Database 1612), then Analyze Database 1614 is triggered to generate a new set of parameter for FIG. 23, Store Profile Table, and FIG. 14, Store Subset—Customer Store Profile Table inserts New Parameters Into Store Cycle 1618, which takes that information and inserts it into the appropriate store's Activity Manger 1602, completing the cycle.

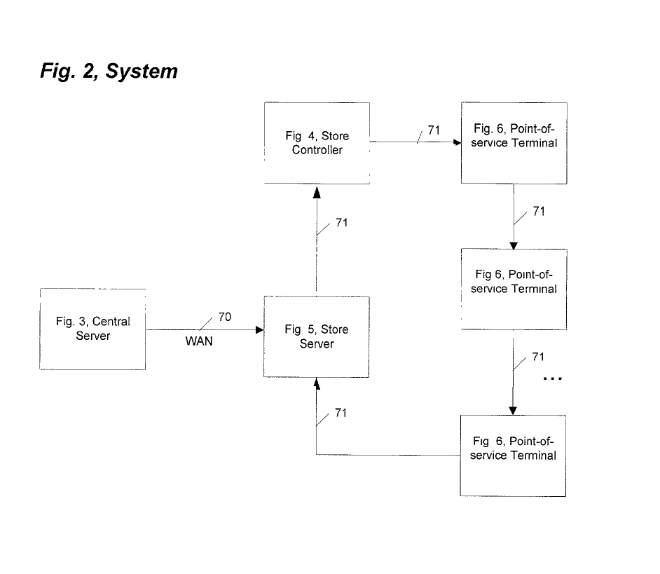

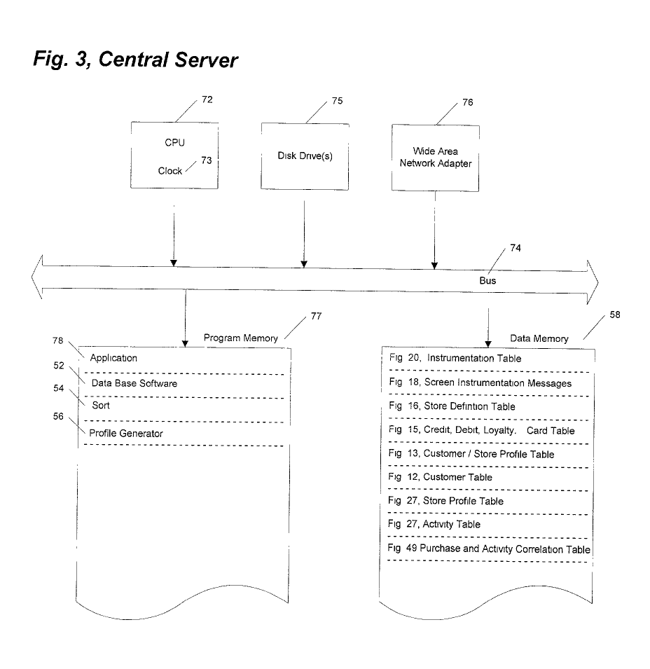

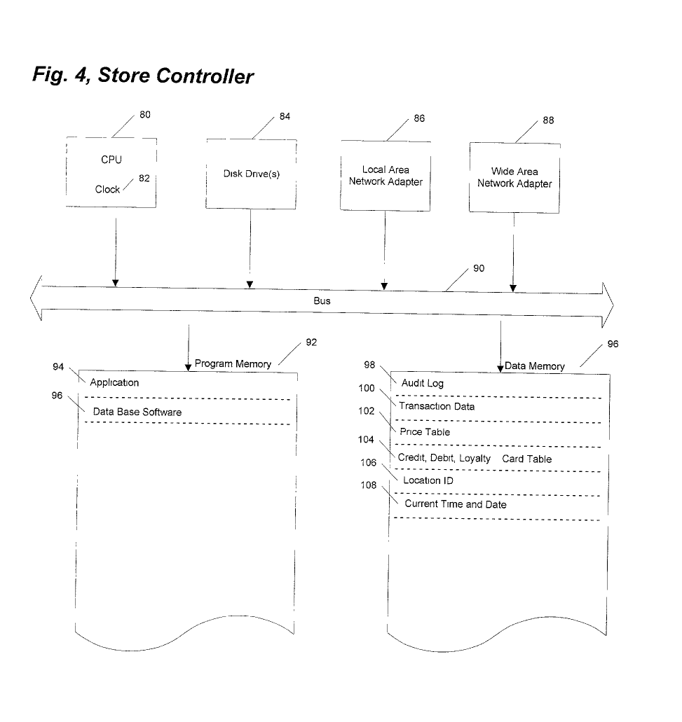

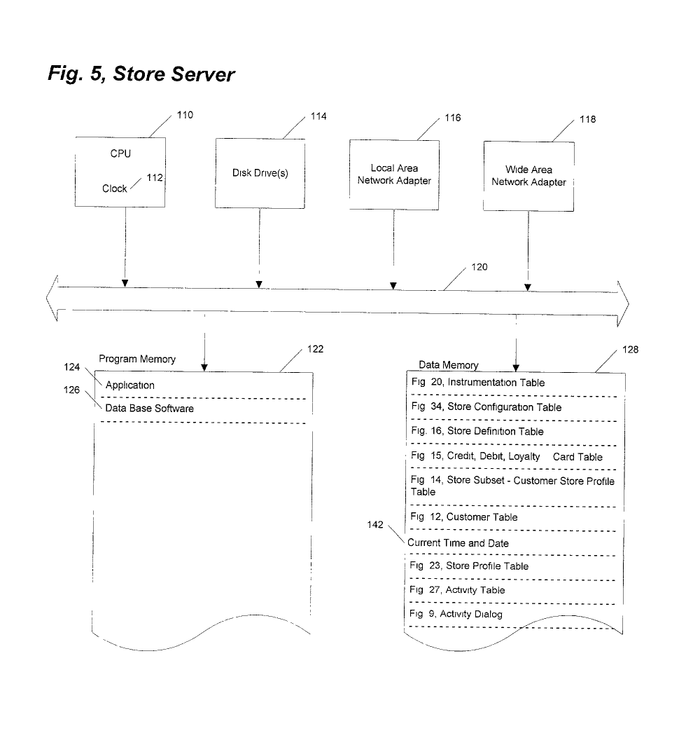

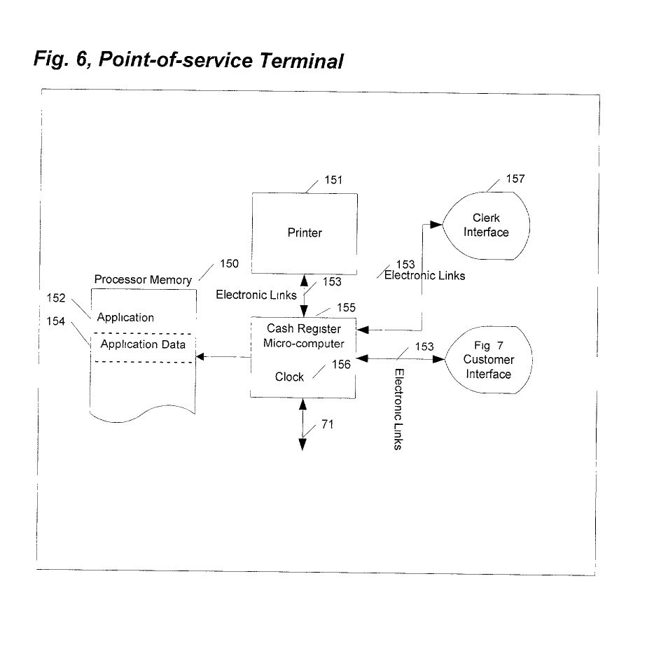

FIG. 2 is a diagram of a network of computers adapted to perform the method of the invention. FIG. 3, Central Server is coupled by a WAN 70 (Wide Area Network), to one or more FIG. 5, Store Servers. Readily available software and protocols such a TCP/IP are used by FIG. 3, Central Server and FIG. 5, Store Server to communicate with each other via WAN 70. FIG. 4, Store Controller and FIG. 5, Store Server are connected via LAN 71 to one or more FIG. 6, Point-of-service Terminals. Normal Point-of-service Terminal activities are conducted between the FIG. 4, Store Controller and FIG. 6, Point-of-service Terminal. These activities are well documented elsewhere and the details are not important to this invention.

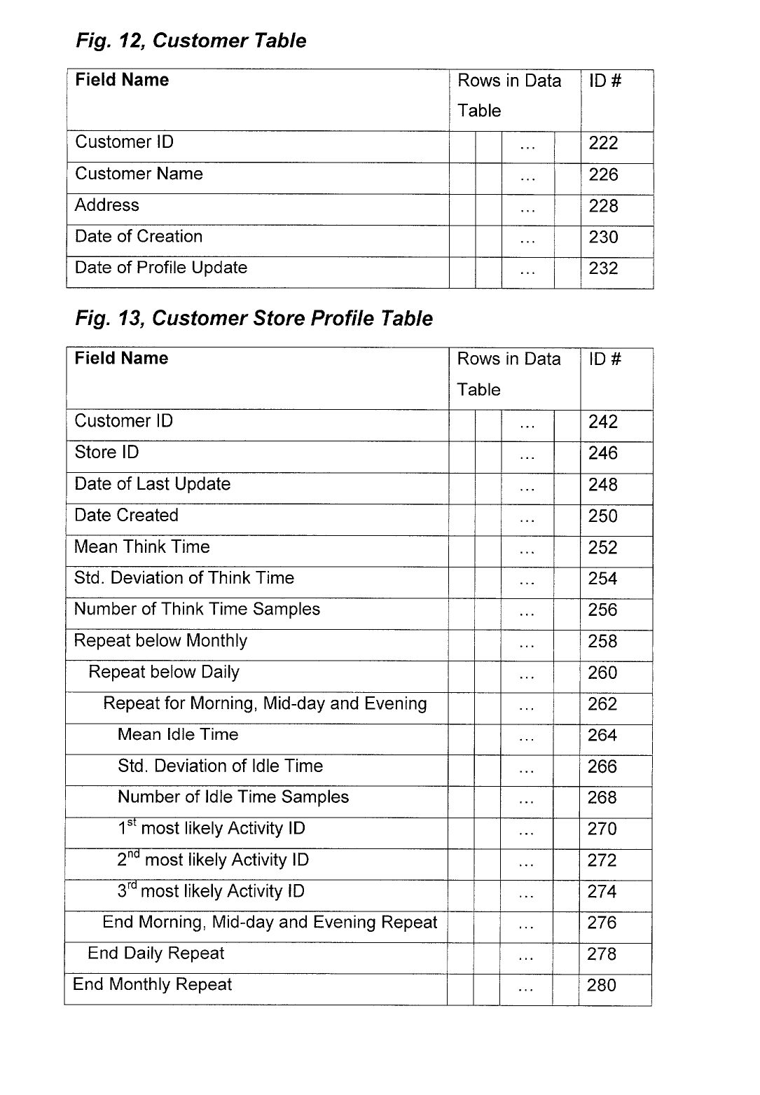

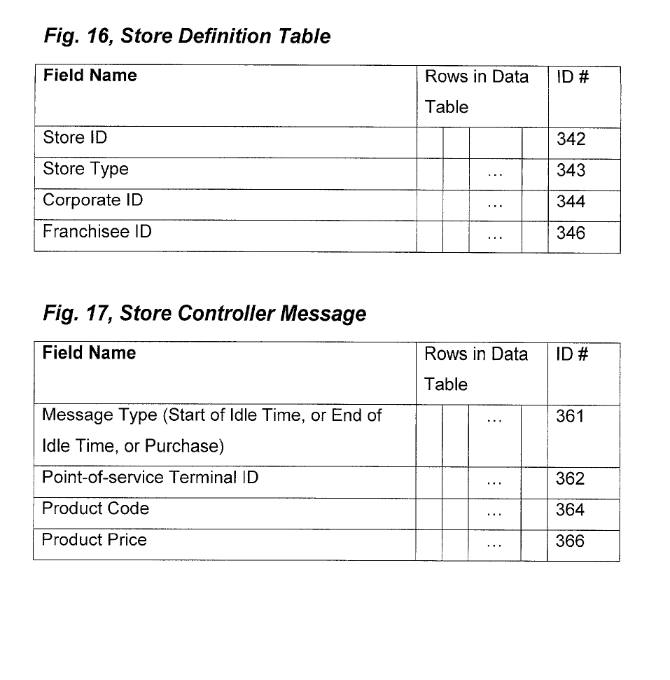

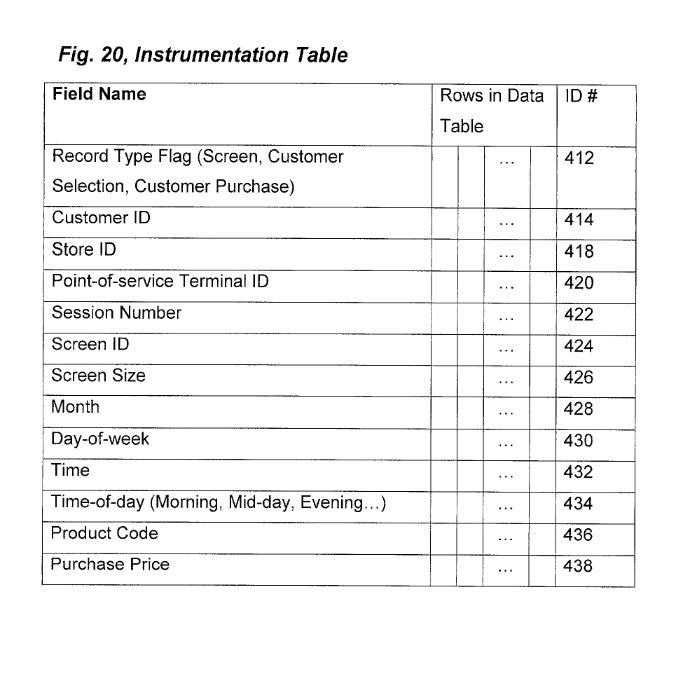

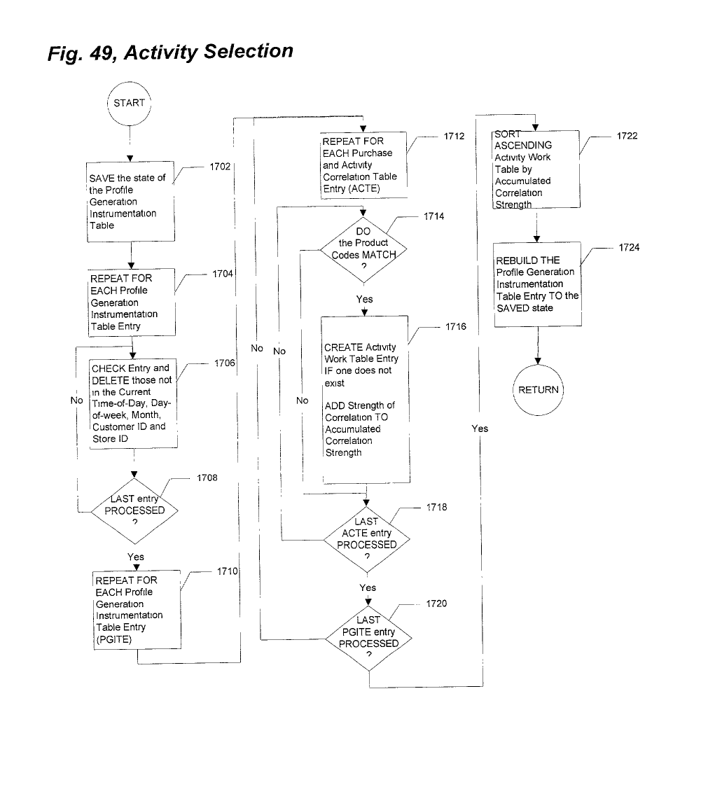

FIG. 3 illustrates further details of the Central Server. It performs the functions of collecting customer data and store data, analyzing the data to extract information concerning buying habits and thinking characteristics of the customer, and information about the performance characteristics of the store. CPU 72 is a conventional microprocessor with a Bus 74 that connects it to Disk Drive(s) 75, a WAN Adapter 76, a Program Memory 77, and a Data Memory 58. CPU 72 contains a Clock 73 that provides time in a form that includes the Month, Day-of-week, Hour, Minute, And Seconds. Program Memory 77 contains Application 78 that performs the following functions. It collects information stored in FIG. 5, Store Server via WAN 70 using standard communication protocols such as TCP/IP. The information collected is in the form of the following tables: FIG. 20, Instrumentation Table; FIG. 18, Screen Instrumentation Messages; FIG. 16, Store Definition Table; FIG. 15, Credit, Debit, Loyalty . . . Card Table; FIG. 13, Customer Store Profile Table; FIG. 12, Customer Table; FIG. 23, Store Profile Table; FIG. 27, Activity Table; and Purchase and FIG. 49, Activity Correlation Table. This information is stored using Database Software 52 into Data Memory 48 and subsequently onto Disk Drive(s) 75.

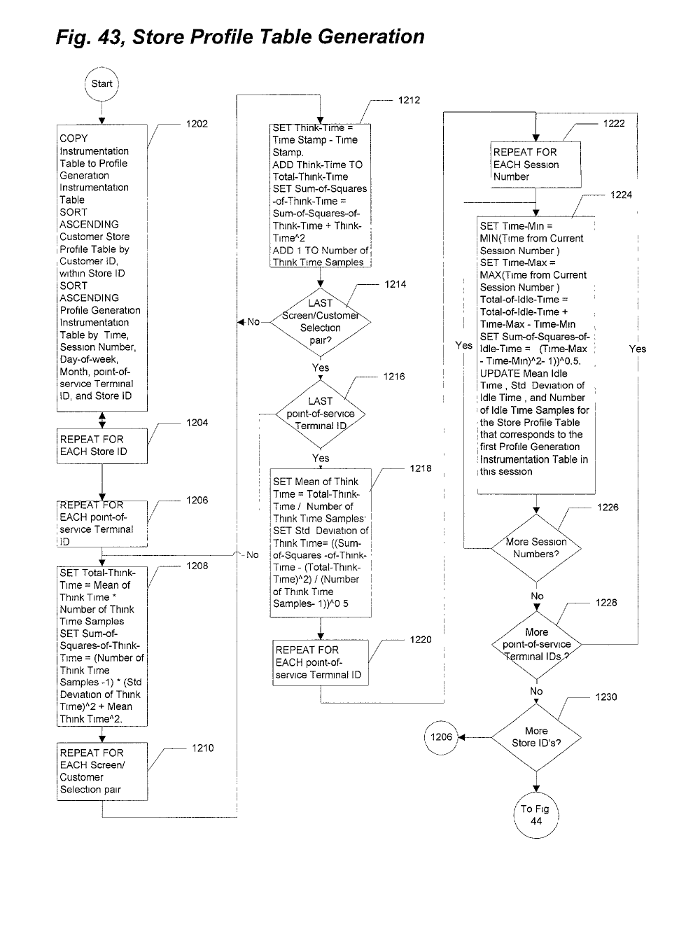

Periodically the data is analyzed to produce the: FIG. 12, Customer Store Profile Table, and FIG. 23, Store Profile Table. See FIG. 43 description below for how this is accomplished. FIG. 12, Customer Store Profile Table and FIG. 23, Store Profile Table are sent to the FIG. 5, Store Server specified in the Store ID 246, and Store ID 512 of the respective table.

FIG. 4 depicts a Store Controller, which performs the functions required in a Point-of-service system that are in support of FIG. 6, Point-of-service Terminals in a location. CPU 80 is a conventional microprocessor with a Bus 90 that connects it to Disk Drive(s) 84, a LAN Adapter 86, a WAN Adapter 88, a Program Memory 92, and Data Memory 96. CPU 72 contains a Clock 73 that provides time in a form that includes the Month, Day-of-week, Hour, Minute, And Seconds. This system typically contains an Audit Log 98, a Price Table 104, a FIG. 15, Credit, Debit, Loyalty . . . Card Table, and a Location ID 106. In addition, Application 94 collects Transaction Data 100 that identifies the customer and the details of the purchase.

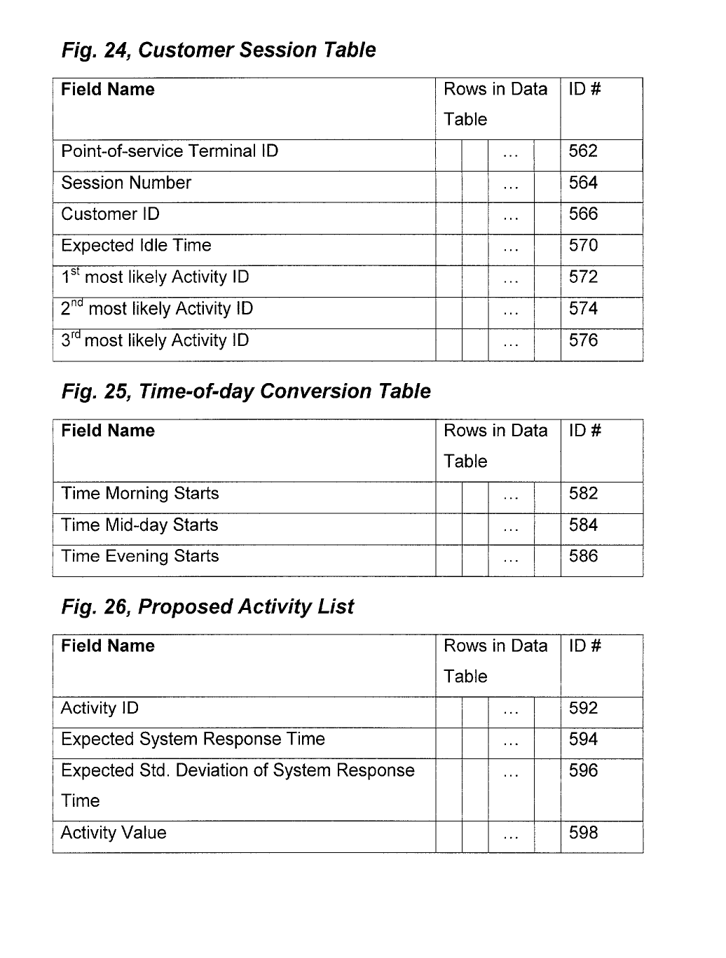

The key function provided by the FIG. 4, Store Controller are signals from Application 94 to FIG. 5, Store Server concerning the start and completion of Check Out Idle Time 1010. These signals comprise the sending of an FIG. 17, Store Controller Message containing Message Type “Idle Time” containing Message ID 362 of ‘Start of Idle Time’ or ‘End of Idle Time’ as appropriate, and Message Type “Purchase” containing Product Code 362 and Product Price 366. When Message Type 361 contains “Idle Time” Point-of-service Terminal ID 362 is included so as to be able to associate the signal with an existing entry in the FIG. 24, Customer Session Table or to create a new entry in the FIG. 24, Customer Session Table.

Data Memory 96 contains Current Time and Date 108 provided from Clock 82 in CPU 82.

FIG. 5 depicts a Store Server. It is described as though it is implemented as a separate computer system, however the function provided can be performed in FIG. 4, Store Controller, other computer systems in the store, or FIG. 3, Central Server. FIG. 5, Store Server communicates with FIG. 3, Central Server via WAN Adapter 118 to acquire the information in Data Memory 128, some of which is stored on Disk Drive(s) 114. The tables acquired are: FIG. 20, Instrumentation Table; FIG. 34, Store Configuration Table; FIG. 16, Store Definition Table; FIG. 15, Credit, Debit, Loyalty . . . Card Table; FIG. 14, Store Subset—Customer Store Profile Table; FIG. 12, Customer Table, FIG. 23, Store Profile Table; FIG. 27, Activity Table; and FIG. 9, Activity Dialog. The rest of the tables are initialized or generated at FIG. 5, Store Server.

Data Memory 128 also contains Current Time and Date 142 provided from Clock 112 in CPU 110. FIG. 5, Store Server also communicates via Local Area Network Adapter 116 to LAN 71 and other components of the system.

FIG. 6 is a diagram of a Point-of-service Terminal, which is configured using a Cash Register Microcomputer 155 of conventional design. The Cash Register Micro-computer 155 contains a Clock 156 that provides time in a form that includes the Month, Day-of-week, Hour, Minute, And Seconds. Attached to the Cash Register Microcomputer 155 are various input and output devices including: a LAN 71, Printer 151, Clerk Interface 157, and FIG. 7, Customer Interface. These are attached via Electronic Links 153, which normally are serial IO like an RS232 serial port. FIG. 7, Customer Interface is used for presenting the actions to the customer and receiving the responses. Cash Register Microcomputer 155 sends FIG. 10, Screens from FIG. 9, Activity Dialog to FIG. 7, Customer Interface on behalf of FIG. 5, Store Server Application 124. It also returns a FIG. 19, Customer Selection Instrumentation Message, which specifies the response to these action alternatives, to FIG. 5, Store Server via LAN 71. Processor Memory 150 contains Application 152 and Application Data 154 needed to run FIG. 6, Point-of-service Terminal.

FIG. 7 depicts a Customer Interface, which has a Customer Interface Microcomputer 172 that is attached via a LAN 71 and/or Electronic Link 153 to FIG. 4, Store Controller and FIG. 5, Store Server (optionally), and is attached to FIG. 5, Store Server via LAN 71. Customer Interface Microcomputer 172 contains a Clock 173 that provides time in a form that includes the Month, Day-of-week, Hour, Minute, And Seconds. FIG. 7, Customer Interface has a Display Screen 170, which can display textual and (optionally) graphical information to the customer. Magnetic Stripe Reader 175 is provided to allow the input of customer identification information from a variety of identification cards. Input Device 161 is used to allow the customer to manually input information. Input Device 161 is typically a keypad or a touch screen. As Customer Interface Microcomputer 172 is programmable, it is capable of performing the various functions described elsewhere. The elements of FIG. 7, Customer Interface are connected by a Electronic Link 153. As implementations vary from manufacturer to manufacturer, more than one Electronic Link 153 may be used. Processor Memory 160 contains Application 162 and Application Data 164 need to run the Customer Interface.

FIG. 8 is a diagram of a structure that represents a Customer Idle Time Dialog, which is composed of a number of screen presentations. The presentations start with a screen called Initial Screen 184, which is a Screen as defined in the FIG. 28, Screen Definition Table. Initial Screen ID 184 is a Screen ID for a screen stored in the FIG. 28, Screen Definition Table. Associated with Initial Screen ID 184 is a list of Screen ID's 188, 192 and 196 that are individually associated with a Selection ID 186, 190, and 194. The selections are activated by Touch Element 860 or FIG. 32, Key Pad Element specified by the various Selection IDs. Customer Dialog Block 182 is a table with a list of the allowable Selection ID's 186, 190, and 194 and Screen ID 188, 192 and 196, of the screen that is to be displayed if that selection is made. Customer Dialog Blocks 182 are chained together using the various Screen IDs. As the Screen ID is used for the linkage, any meshed structure of Customer Dialog Blocks is possible.

FIG. 9 is a diagram of a structure that represents a Customer Activity. It is a subset of a FIG. 8, Customer Dialog. It is composed of Customer Dialog Blocks 201. An FIG. 9, Activity may result in the viewing of an advertisement, the issuance of a coupon, the sale of a product or service . . . through the presentation of a number of screens, as directed by the selections made by the customer as the screens are presented. Customer Dialog Blocks 201 are navigated as in the description in FIG. 8. Activity's Screen ID 202 fills the same function as Initial Screen ID 184 for FIG. 9, Activity. It is the anchor point for the various screens required to accomplish an activity.

FIG. 10 is a diagram showing the elements of a Screen and associated Manual Input Areas 214. In this embodiment, FIG. 10, Screen is composed of one or more Sub-screens 42. Each Sub-screen 212 contains graphical and/or text elements that occupies an area of FIG. 10, Screen. These Sub-screens may be associated with a key on a keypad or a touch area on FIG. 10, Screen. These are called Manual Input Areas 214. FIG. 10, Screen has a Screen ID 384. The definition of a FIG. 10, Screen can be found in the FIG. 28 Screen Definition Table.

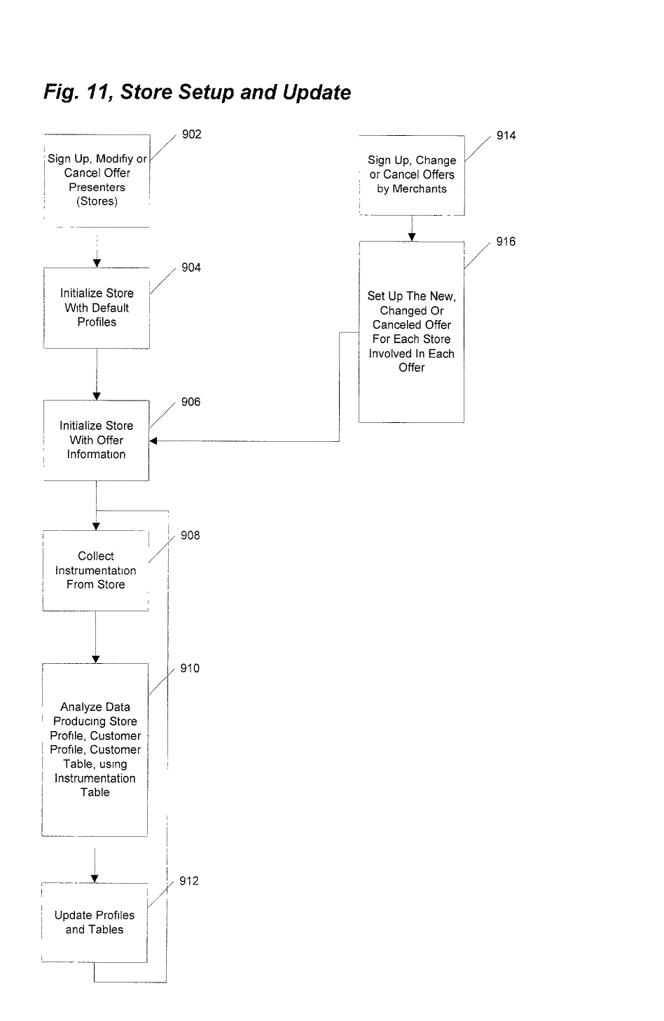

FIG. 11 is a diagram showing Store Setup and Update process. Two independent sources start the process. Step 902 describes the sign up, modification or cancellation of a retail entity concerning its stores' participation in presenting offers to customers, and the collection of various data, as is found in the FIG. 16. Store Definition Table. This information is communicated from FIG. 3, Central Server to FIG. 5, Store Server via WAN 70 and is stored in FIG. 5, Store Server Data Memory 128 and subsequently to a Disk Drive 114 as in step 904.

Independently, as in step 914, merchants sign up to make, modify, or cancel offers through the various stores participating in the overall system. Step 916 shows the collection of various data that describes the sales campaign they wish to conduct. These activities result in building, for each store Involved In each offer, the various Screens FIG. 10, FIG. 9, Activities, FIG. 28, Screen Definition Table entries, FIG. 29, Text Element Table entries, FIG. 30, Graphic Element Table entries, Touch Element Table 860 entries, and FIG. 32, Keypad Element Table entries. These are sent to FIG. 5, Store Server in the stores involved with the offer (Step 906).

In Step 908 the FIG. 5, Store Server activates the instrumentation in FIG. 7, Customer Interface, which begins sending FIG. 18, Screen Instrumentation Messages and FIG. 19, Customer Selection Instrumentation Messages to FIG. 5, Store Server. These are accumulated in FIG. 23, Instrumentation Table. When that table is filled to a preset level, the contents of FIG. 23, Instrumentation Table are sent to FIG. 3, Central Server, where it is merged with FIG. 23, Instrumentation Table at FIG. 3, Central Server. FIG. 5, Store Server's FIG. 23, Instrumentation Table is then reset to empty awaiting more entries.

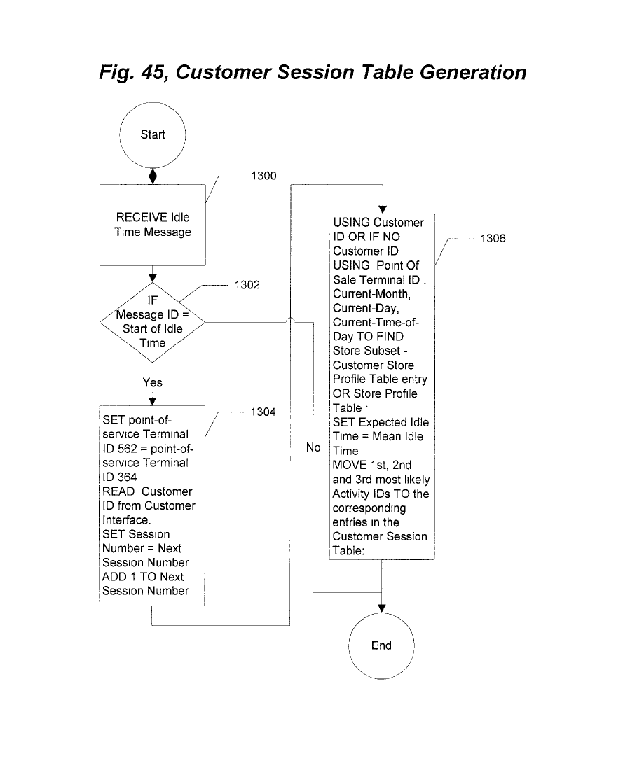

In Step 910, an analysis process is started periodically in FIG. 3, Central Server, using current FIG. 20, Instrumentation Table; FIG. 13, Customer Store Profile Table; FIG. 23, Store Profile Table; FIG. 16, Store Definition Table; Customer Table FIG. 12; and FIG. 15,Credit, Debit, Loyalty . . . Card Table to construct updated FIG. 13, Customer Store Profile Tables; FIG. 14, Store Subset—Customer Store Profile Table; and FIG. 23, Store Profile Tables, as described in the FIG. 43 Store Profile Table Generation and FIG. 45. Customer Store Profile Table Generation.

In Step 912 these updated FIG. 14, Store Subset—Customer Store Profile Tables and FIG. 23, Store Profile Tables, are sent back to the Store IDs as specified in Store IDs 294 and 512.

This process continues by repeating Steps 908, 919 and 912.

FIG. 12 illustrates Customer Table that contains a Customer ID 222 which is the ID provided to the retailer by the customer in the course of the primary transaction being performed. It may be a credit card number or other ID, or no ID (anonymous ID). It also contains Customer Name 226, Address 228, Date of Creation 230, and Data of Profile Update 232.

FIG. 13 is a data table that describes Customer Store Profile Table. This profile contains the information about the customer's time consumption habits in various circumstances. Customer ID 242 identifies a unique customer or a class of customers. If a class of customers is to be represented a unique identifier must be assigned for each class and stored in Customer ID 242 for the FIG. 13, Customer Store Profile Table entry associated with said class. Said class could include customers from one or more venues that share one or more characteristics. Store ID 246 identifies the store the FIG. 13, Customer Store Profile Table applies to. The Date of Last Update 248 is a control field that is used to trigger periodic updates of the table. Date Created 250 is the date the first table was generated by the system. Mean Think Time 252 is the estimated think time for the customer in the specified store. The Std. Deviation of Think Time 254 is standard deviation of the think time samples collected at the time the table was last updated. Number of Think Time Samples 256 is used to eliminate the need to maintain a historical database of think time samples beyond the current sample period. To maintain this value, Mean Think Time 252 and Std. Deviation of Think Time 254 use their previous values and the current samples.

A number of statistics are maintained in the FIG. 13, Customer Store Profile Table concerning customer idle time. The fields are: Mean Idle Time 264, Std. Deviation of Idle Time 266, Number of Idle Time Samples 268, 1^{st} most likely Activity ID 270, 2^{nd} most likely Activity ID 272, and 3^{rd} most likely Activity ID 274. These values are repeated for morning, mid-day, and evening for each day of the week and each month, for a total of 252 repetitions. Mean Idle Time 264 and Std. Deviation of Idle Time 266 are computed from the information collected in Screen Instrumentation Table 300 and Customer Selection Instrumentation Table 320, using Number of Idle Time Samples 268 as described above for Number of Think Time Samples 256. The table is generated and stored at FIG. 3, Central Server.

FIG. 14 is the Store Subset—Customer Store Profile, a subset of the FIG. 13, Customer Store Profile Table that contains the information needed by FIG. 5, Store Server. It is extracted from Customer Store Profile FIG. 13 by copying the common fields.

FIG. 15 is the Credit, Debit, Loyalty . . . Card Table. The table associates Card ID 332 with a Customer Name 334 and Customer ID 336, which is assigned by FIG. 3, Central Server when the customer is initially added to the system.

FIG. 16 is the Store Definition Table. The table contains a Store ID 342 which uniquely identifies the store; Store Type 343 which is used, optionally, to build FIG. 13, Customer Store Profile Tables that span instances of the same Store Type 343 or to build Store Profile Tables that span instances of the same Store Type 343; a Store a Corporate ID 380 which uniquely identifies the company or franchiser associated with the store; and Franchisee ID 346 which is used when the store is a franchise and uniquely identifies the franchisee. FIG. 16, Store Definition Table is built by FIG. 3, Central Server as stores are entered into the system.

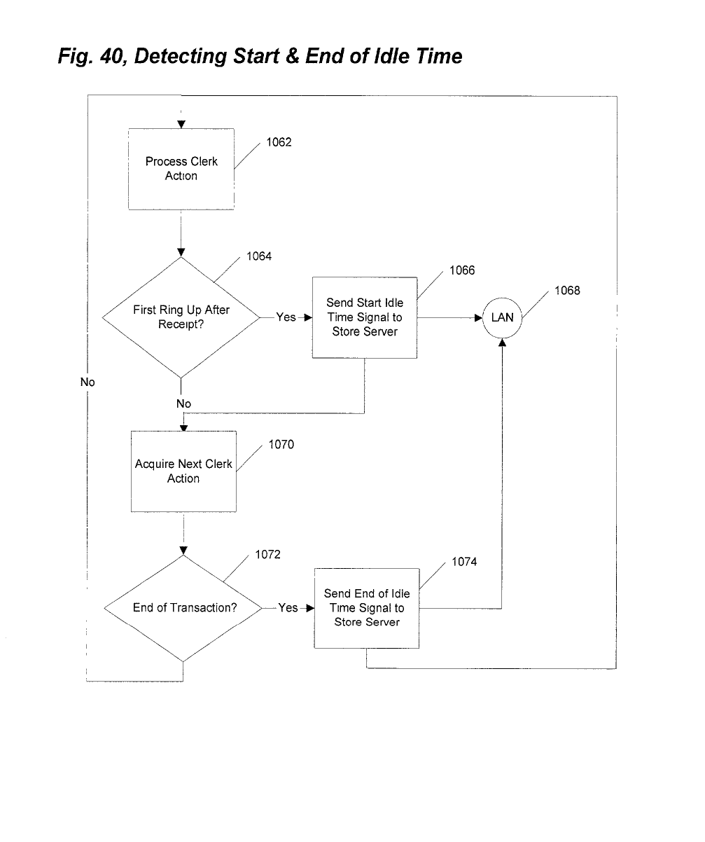

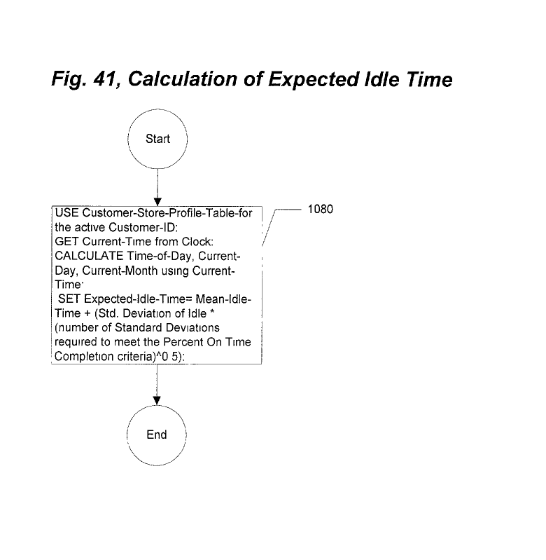

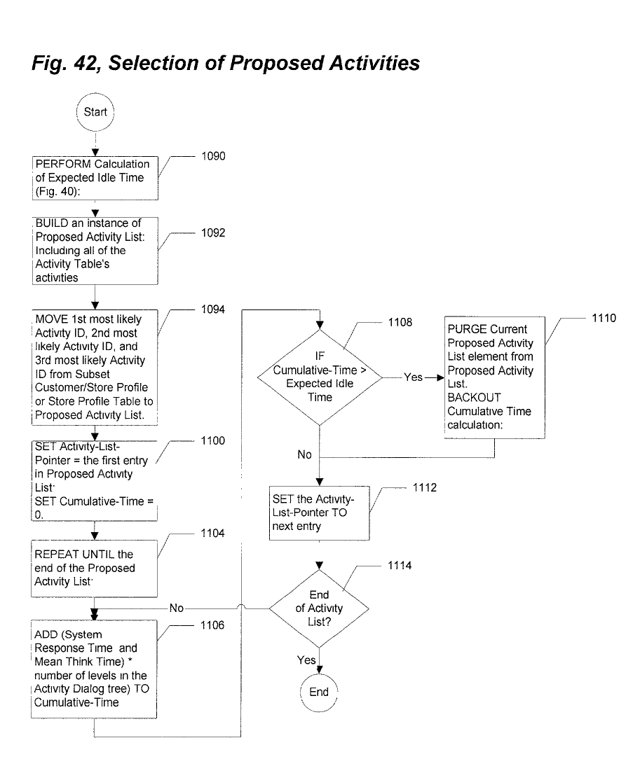

FIG. 17 depicts the Store Controller Message. These signals are messages generated by FIG. 4, Store Controller when it detects the start or stop of idle time as described in FIG. 40 or indicate Product Code 364 and Product Price 366 of products purchased. Message Type 361 indicates whether the message is a “Start of Idle Time”, “End of Idle Time”, or “Purchase”. Point-of-service Terminal ID 362 specifies which terminal the information is provided for. This is then associated to a specific customer via FIG. 14, Customer Session Table's Point-of-service Terminal 562 field. Product Code 364 specifies a unique code for each product. This is normally in the form of the Universal Product Code standard. Product Price 366 is the price of the product.

FIG. 18 is a data structure that describes the Screen Instrumentation Message. The message is generated by FIG. 7, Customer Interface when it presents a screen, as defined in the FIG. 28, Screen Definition Table, and is sent to FIG. 5, Store Server for forwarding to FIG. 3, Central Server where it is placed in a table with the same format. Message Type 372 is a constant and is generated by Application 152 in FIG. 6, Point-of-service Terminal. Customer ID 374 is extracted from the FIG. 24, Customer Session Table, as are: Store ID 378, Point-of-service Terminal ID 362, and Session Number 382. Screen ID 384 and Size 386 are extracted from the current Customer Dialog Block 61. Time Stamp 388 is generated from Customer Interface Micro-processors 908 internal clock.

FIG. 19 is a data structure that describes a Customer Selection Instrumentation Message. The FIG. 19, Customer Selection Instrumentation Message is generated by FIG. 7, Customer Interface when it detects a touch or key press as defined in the FIG. 28, Screen Definition Table, Element ID 808, or the purchase of a product. The specific type is noted in the Record Type 392. It is sent to FIG. 5, Store Server for forwarding to FIG. 3, Central Server where it is placed in a table with the same format. Message Type 392 is a constant and is generated by Application 152 in FIG. 6, Point-of-service Terminal. Customer ID 394 is extracted from the FIG. 24, Customer Session Table, as are: Store ID 398, Point-of-service Terminal ID 400, and Session Number 402. In the case of a customer selection, Screen ID 404 and Selection ID 406 are extracted from the current Customer Dialog Block 61. In the case of a customer purchase, Purchase Price 406 and Product Code 404 are extracted from the FIG. 4, Store Controller. Time Stamp 408 is generated from the Customer Interface Micro-processor's 172 internal Clock 173.

FIG. 20 is an Instrumentation Table that describes a collection of FIG. 18, Screen Instrumentation Messages and FIG. 19, Customer Selection Instrumentation Messages. Record Type Flag 412 distinguishes between these. The FIG. 20, Instrumentation Table is generated by FIG. 5, Store Server when it receives FIG. 18, Screen Instrumentation Messages and FIG. 19, Customer Selection Instrumentation Messages from FIG. 6, Point-of-service Terminal. The Month 428, Day-of-week 430, Time 432, and Time-of-day 434 are calculated from the Time Stamp 388 from the corresponding FIG. 19, Customer Selection Instrumentation Message or FIG. 18, Screen Instrumentation Message by use of a conventional conversion routine. Product Code 436 and Purchase Price 438 are used when Record Type Flag 412 contains “Customer Purchase”. Otherwise, it is unused. They are initialized from Product Code 404 and Purchase Price 406.

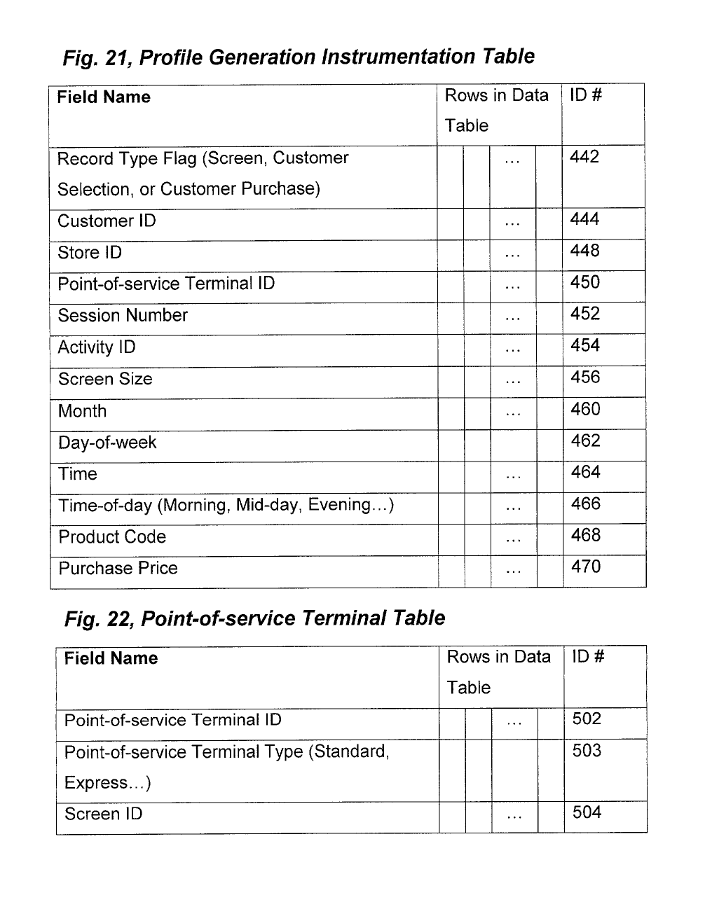

FIG. 21, Profile Generation Instrumentation Table, is a copy of the FIG. 20, Instrumentation Table that is used to generate Customer Store Profile Tables 120. That process is described under FIG. 23 Store Profile Table, below.

FIG. 22 is a Point-of-service Terminal Table, which associates a Screen ID 504 with a Point-of-service Terminal ID 502. That screen is presented at End Of Session 1016 at FIG. 6, Point-of-service Terminal specified by Point-of-service Terminal ID 502.

FIG. 23 is a Store Profile Table. It is supplied from FIG. 3, Central Server as part of a periodic download process. Store ID 512 is a unique identifier assigned by FIG. 3, Central Server when the store is added to the system. Point-of-service Terminal ID 514 links the profile to a specific FIG. 6, Point-of-service Terminal in the store. For example, the Express Checkout Lane in a store would have a different FIG. 23, Store Profile Table entry than the normal Checkout Lanes. Date Created entry 516 is assigned by FIG. 3, Central Server when the store is added to the system. Date of Last Update entry 518 is the date when the current profile was generated. It is set by FIG. 3, Central Server during Profile Generation. Mean of Think Time entry 520 is set by the process described in FIG. 43, Store Profile Generation by averaging the time differences between Time 432 in the FIG. 20, Instrumentation Table for Message Type 412=‘Screen’ and the next Time 432 for Message Type 412=‘Customer Selection’ for the FIG. 20, Instrumentation Table for entries with the same Point-of-service Terminal ID 420 and Store ID 418. This is done by sorting the FIG. 20, Instrumentation Table into ascending sequence by Store ID 418, Point-of-service Terminal ID 420, Month 428, Day-of-week 432 and Time 434 and summarizing from the sorted table. The Std. Deviation of Think Time 522 is similarly calculated using the well-known formulas for calculation of the standard deviation of a set of numbers. The Number of Think Time Samples 524 is the count of samples used to calculate Mean of Think Time 520. A number of fields are repeated for morning, mid-day, and evening for each day of the week. The weekly information is repeated for each month. The data elements repeated are: Mean Idle Time 532, Std. Deviation of Idle Time 534, Number of Idle Time Samples 536, 1^{st} most likely Activity ID 538, 2^{nd} most likely Activity ID 540, and 3^{rd} most likely Activity ID 542.

Mean Idle Time 532, Std. Deviation of Idle Time 534, Number of Idle Time Samples 536 can be calculated by sorting the FIG. 20, Instrumentation Table into ascending sequence by Store ID 418, Point-of-service Terminal ID 420, Customer ID 414, Session Number 422, Month 428, Day-of-week 430, and Time-of-day 434 and summarizing from the sorted table. The difference between the time of the first and last entries in the FIG. 20, Instrumentation Table for a given Session Number 422, less the time between the presentation of the Payment Screen and receiving the Customer Selection, is the idle time for that Customer Session 422. These individual idle times are used to calculate the Mean Idle Time 532, Std. Deviation of Idle Time 534, and Number of Idle Time Samples 536. 1^{st} most likely Activity ID 538, 2^{nd} most likely Activity ID 540, and 3^{rd} most likely Activity ID 542 are generated as described in FIG. 43, Store Profile Generation.

Home Screen ID 550 is extracted from the FIG. 22, Point-of-service Terminal Table by finding the entry that matches Point-of-service Terminal ID 514. Percent On Time Completion 554 is the percentage of time that the idle time activities will complete prior to the end of the idle time. It is selected by store management to meet their objectives and is based on their judgment of a correct balance between utilization of customer idle time and utilization of the checkout counter for the primary business of the store.

FIG. 24 depicts the Customer Session Table that is constructed as in FIG. 45, Customer Session Table Generation, at the point the customer is identified during Checkout Idle Time 1010. It contains Session Number 564, which is set from Next Session Number 914. Customer ID 566 is provided by the customer, generally by passing an identification card Magnetic Stripe Reader 28. FIG. 14, Store Subset—Customer Store Profile Table is located by using Customer ID 294 to find the entry, and the time from Customer Interface Microprocessors 172 internal Clock 173 is used to locate: Mean Idle Time 306, Std. Deviation of Idle Time 308, 1^{st} most likely Activity ID 310, 2^{nd} most likely Activity ID 312, and 3^{rd} most likely Activity ID 314, which are entered into the corresponding fields of the FIG. 24, Customer Session Table.

FIG. 25 is the Time-of-day Conversion Table that is used to convert a clock value from the time of day in terms of Morning, Mid-day, and Evening. Time Morning Start 582 is the clock value that defines the start of Morning. Any clock value between Time Morning Start 582 and Time Mid-day Start 584 is Morning. Any clock value between Time Mid-day Start 584 and Time Evening Start 586 is Mid-day. Any clock value between Time Evening Start 586 and Time Morning Start 582 is Evening. Note: this table is readily expanded to handle more than three times per day.

FIG. 26 is Proposed Activity List to be presented to a customer. The FIG. 26, Proposed Activity List is copied from the FIG. 27, Activity Table. The first three entries are 1^{st} most likely Activity ID 572, 2^{nd} most likely Activity ID 574, and 3^{rd} most likely Activity ID 576; followed by the rest of the entries in the FIG. 27, Activity Table in descending Activity Value 598 order. Then, based on Expected Idle Time 570 from the FIG. 24,Customer Session Table, the Expected System Response Time 594 and the Expected Std. Deviation of System Response Time 606 from the FIG. 27, Activity Table, and Mean Think Time 296 and Std. Deviation of Think Time 298 from the FIG. 14, Store Subset—Customer Store Profile Table; the FIG. 26, Proposed Activity List is purged of activities beyond the entry that will satisfy the Percent On Time Completion 554 criteria from FIG. 23, See FIG. 42, Selection of Proposed Activity for a flow chart implementation of this.

FIG. 27 is the Activity Table that has all the activities offered in the store. It contains Activity ID 602 and Screen ID 604, which is a Screen ID 202 for a first screen in a FIG. 9, Activity; and Activity Value 608, which is value to the business entities that are involved in the offering associated with the activity.

Activity Type 610 identifies the type of activity. Some of the activities include advertisements, information presentations, product offers, service offers, information queries . . . This allows the system to offer a broad range of activities, including the sale of products and services. Activity Price 612 permits the presentation of the price to the customer.

FIG. 28 is a Screen Definition Table that is the anchor point for the generation of a screen. It is composed of: a Screen ID 802 which is a unique identifier assigned by FIG. 3, Central Server during the screen definition process; an X Dimension 804 and a Y Dimension 806 that define the size of the screen to be presented; a list of Sub-screen Elements composed of entries from the FIG. 29,Text Element Table, FIG. 30, Graphic Element Table, FIG. 31, Touch Element Table and FIG. 32, Key Pad Element Table. These are described below.

FIG. 29 is a Text Element Table, which is composed of: Text Element ID 822, a unique identifier assigned by the FIG. 3, Central Server and downloaded into the FIG. 5, Store Server periodically; a Text Element Flag 824 which is used to identify an entry as a text element when it is copied into the FIG. 28, Screen Definition Table; an X Position 826 and a Y Position 828 that specify the upper leftmost location on the screen where the text is to be placed; Font 830 which specifies which type font to use when displaying the text; Style 832 (Bold, Underlined, Italic . . . ) of font to use for the text; Length 834 in bytes of the following field which contains the text; and Text 836 which contains the text to be displayed.

FIG. 30 is a Graphic Element Table, which is composed of: Graphic Element ID 842, a unique identifier assigned by FIG. 3, Central Server and downloaded into FIG. 5, Store Server periodically; a Graphic Element Flag 844 which is used to identify an entry as a graphic element when it is copied into the FIG. 28, Screen Definition Table; an X Position 846 and a Y Position 848 that specifies the upper leftmost location on the screen where the text is to be placed; the Graphic's Type 850 (tiff, GIF . . . ) which specifies the format of the graphic; Size 852 of Graphic 854 in bytes; and Graphic 854 which contains the graphic to be displayed.

FIG. 31 is a Touch Element Table, composed of: Touch Element ID 862, a unique identifier assigned by FIG. 3, Central Server and downloaded into FIG. 5, Store Server periodically; a Touch Element Flag 864 which is used to identify an entry as a touch element when it is copied into the FIG. 28, Screen Definition Table; an X1 Coordinate 866 and a Y1 Coordinate 868 that specify the upper leftmost location on the screen that is to be active as a touch area, which in conjunction with the X2 Coordinate 870 and Y2 Coordinate 872 that specify the lower rightmost location on the screen that is to be active as a touch area, define a touch area, which if touched by the customer is associated with Selection ID 874 which uniquely identifies the customer response.

FIG. 32 is a Key Pad Element Table which is composed of: Key Pad Element ID 882, a unique identifier assigned by FIG. 3, Central Server and downloaded into FIG. 5, Store Server periodically; a Key Pad Element Flag 884, which is used to identify an entry as a key pad element when it is copied into the FIG. 28, Screen Definition Table; a Key ID 886 which if touched by the customer is associated with Selection ID 874 which uniquely identifies the customer response.

FIG. 33 is the Activity Work Table, which is composed of Activity ID 902 and Count 904. It is used to find the most likely activities in the FIG. 14, Store Subset—Customer Store Profile Table, and FIG. 23, Store Profile Table.

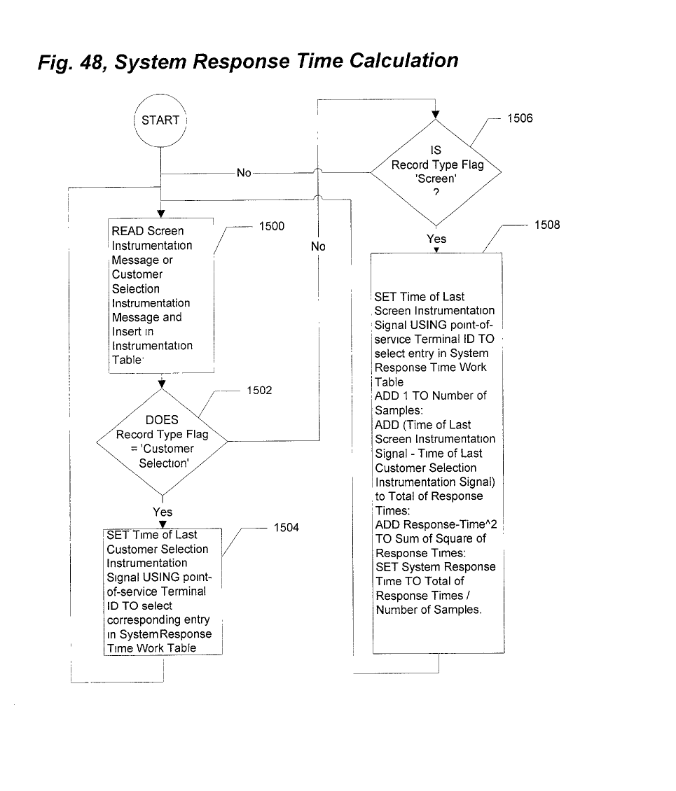

FIG. 34 is the Store Configuration Table, which is composed of Store ID 912 and Next Session Number 914. Next Session Number 914 is initialized with the value of zero. It is incremented by one each time a Session Number 564 in the FIG. 24, Customer Session Table is assigned. When the field overflows, it is reset to zero. The field size is picked such that Session Numbers 914 assigned in one 24-hour period are unique. System Response Time 916 is calculated dynamically as shown in FIG. 48, System Response Time Calculation. FIG. 34, Store Configuration Table is built by FIG. 5, Store Server at system bring up. This table is in FIG. 5, Store Server and has one entry for the store.

FIG. 35, System Response Time Work Table, which is composed of: point-of-service Terminal ID 932 which identifies the terminals in the store where the table is sited; Time of Last Customer Response Instrumentation Signal 934; Time of Last Screen Instrumentation Signal 936; Number of Samples 938 of System Response Time; Total of Response Times 940; Sum of Square of Response Times 942; and System Response Time 944. This table is in FIG. 5, Store Server and has one entry for each FIG. 6, Point-of-service Terminal in the store.

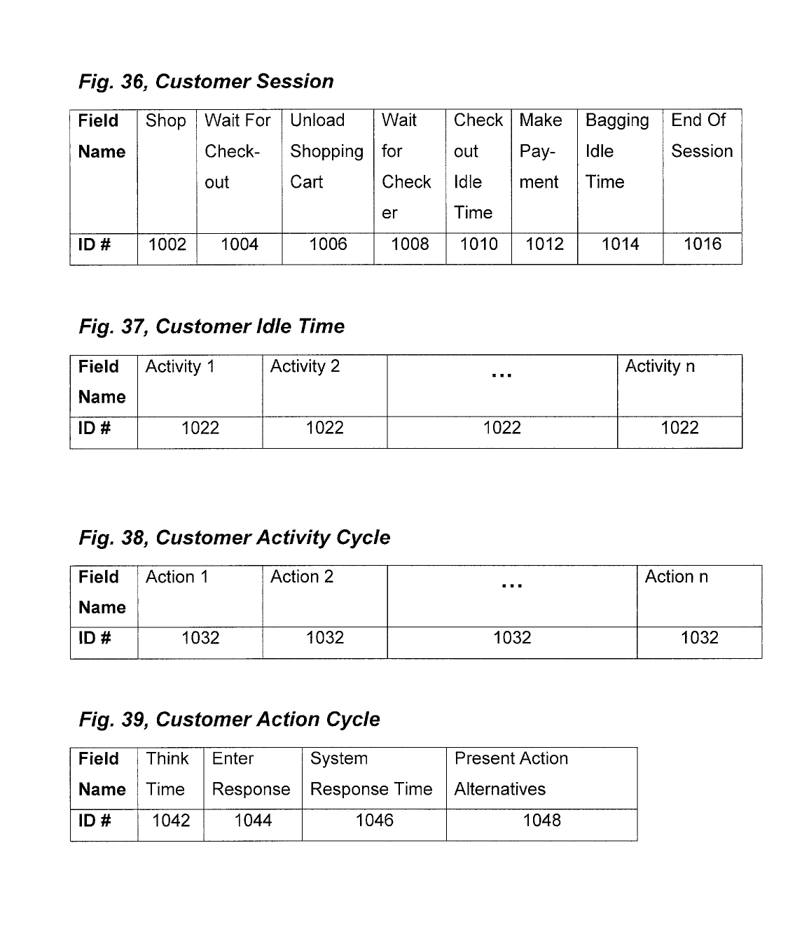

FIG. 36, Customer Session, is a diagram that describes a typical FIG. 36, Customer Session in a supermarket. It will be explained in the terms of a grocery store, but applies, with minor variations to most, if not all Point-of-service venues. This diagram illustrates the normal flow of a customer in a store. The first customer activity is to Shop 1002. When the shopping list has been filled, the customer enters a Wait For Checkout 1004. Eventually the customer reaches the point where he/she can Unload Shopping Cart 1006 and after having done so will Wait for Checker 1008. Once the checker is available and starts to process the order, the customer enters Checkout Idle Time 1010. When all the items have been rung up, the customer is asked to Make Payment 1012. After this is completed, the customer has a Bagging Idle Time 1014 and then proceeds to vacate the checkout counter at End of Session 1016. Checkout Idle Time 1010 and Bagging Idle Time 1014 constitute the time available (Idle Time) for the customer to engage the FIG. 7, Customer Interface to perform other activities.

FIG. 37 is a diagram that describes how Customer Idle Time is used. The system proposes a series of activities (Activity 1 1022, Activity 2 1022 through Activity n 1022. These activities are selected based on the Expected Idle Time 570 for the FIG. 36, Customer Session. That Expected Idle Time is calculated as shown in FIG. 41. The selection of Activities is described in FIG. 42.

FIG. 38 is a diagram that describes a Customer Activity Cycle. The FIG. 38, Customer Activity Cycle is composed of one or more Actions 1032. These Actions 1032 involve the presentation of a FIG. 10, Screen with a set of Selections 874 that constitute the customer's response to the screen. The FIG. 38, Customer Activity Cycle starts with the ‘Start of Idle Time’ in the FIG. 17 Idle Time Message and ends with the ‘End of Idle Time’ in the related FIG. 17 Idle Time Message.

FIG. 39 is a diagram that describes a Customer Action Cycle. The FIG. 39, Customer Action Cycle is viewed from the customer's perspective in that it starts with a screen displayed on the Customer FIG. 10, Screen. The customer reads and thinks about the information presented during Think Time 1042. Once a decision is made, the customer responds during Enter Response 1044. The system evaluates the response which is in the form of a Selection ID 874 and then at the end of System Response Time 1046, Presents Action Alternatives 1048 in the form of next FIG. 10, Screen to the customer by selecting a Screen ID 188, 192, 196 . . . associated with Selection ID 186, 188, 192 . . . in the Customer Dialog Block 182. This cycle repeats for each Action 1032 in the FIG. 38, Customer Activity Cycle.

FIG. 40 is a flow chart for Detecting Start and End of Idle Time. The flow chart illustrates a portion of the main loop in a conventional cash register. Each time a clerk takes an action, the Process Clerk Action Ring Up 1062 step is performed, and then a test is made in the First Ring Up After Receipt 1064 decision step. If the answer is ‘Yes’, Step 1066 sends a message to the FIG. 5, Store Server via the LAN 71 containing FIG. 17, Idle Time Message with a Message ID 362 indicating ‘Start of Idle Time’, and then returns the flow to Step 1070. If the answer generated in Step 1064 was ‘No’, flow continues to Acquire Next Clerk Action 1070 and then on to End of Transaction 1072, where the decision is made as to whether the next action is the end of the current customer's transaction. If yes, control flows to Step 1074 which sends a message to the FIG. 5, Store Server via the LAN 71 containing FIG. 17, Idle Time Message with a Message ID 362 indicating ‘End of Idle Time’, and then returns the flow to Process Clerk Action 1062. Otherwise, flow goes directly to Process Clerk Action 1062, where the normal checkout processing is performed for the action.

FIG. 41 is a flow chart describing the calculation of Expected Idle Time 570. In Step 1800, using the Customer ID 566 from FIG. 14, Customer Session Table, FIG. 14, Store Subset—Customer Store Profile Table and Time-of-Day, Current-Day, Current-Month (derived from the current time): Then the Number Of Standard Deviations required to meet and Percent On Time Completion 554 is calculated using standard statistical formulas. The square root value is multiplied by Std. Deviation of Idle Time 534 for the Time-of-Day, Current-Day, and Current-Month. The product is added to the Mean Idle Time 532, for the Time-of-Day, Current-Day, and Current-Month, giving Expected Idle Time 570.

FIG. 42 is a flow chart, entitled Selection of Proposed Activities, describing the construction of a FIG. 26, Proposed Activity List. Step 1090 using FIG. 41, Calculation of Expected Idle Time, calculates Expected Idle Time 570. Step 1092 builds a new instance of a FIG. 26, Proposed Activity List for this customer session and primes the table with the activities from the FIG. 2, Activity Table. Step 1094 inserts the three most likely activities from the FIG. 14, Subset Customer Store Profile or FIG. 23, Store Profile Table (if the FIG. 14Subset Customer Store Profilefor Customer ID 566 does not exist) into the head of the FIG. 26, Proposed Activity List. Step 1100 sets the Activity-List-Pointer (it points to the ‘current’ item in the list) to the first item in the FIG. 26, Proposed Activity List and initializes Cumulative Time to zero.

Step 1106 sums the time taken for the current Activity 1022 by adding: the product of Mean of Think Time 520 and the number of Actions 1032 in the Activity 1022, and Expected System Response Time 594 to Cumulative-Time.

Step 1108 tests Cumulative-Time to see if it exceeds the Expected Idle Time 570.

Step 1110 is executed in the case where the last activity did not fit into Expected Idle Time 570. The calculation in Step 1106 is nullified and the current Activity is deleted from the FIG. 26, Proposed Activity List. This makes the next activity the current activity, so control is passed to Step 1114.

Step 1112 sets the Activity-List-Pointer to the next Activity on the List.

Step 1114 checks to see if the last activity has been processed. If so the process is ended. Otherwise, control is passed to Step 1106, continuing the process.

FIG. 43, Store Profile Table Generation describes how the FIG. 23, Store Profile Table is constructed.

Step 1202 copies FIG. 20, Instrumentation Table to FIG. 21, Profile Generation Instrumentation Table, sorts the: FIG. 13, Store Profile Table into ascending sequence by Store ID 246; and then sorts FIG. 21, Profile Generation Instrumentation Table into ascending sequence by: Time 464, Session Number 452, Day-of-week 462, Month 460, Point-of-service Terminal ID 450, and Store ID 448.

Step 1204 sets up a loop, based on Store ID 448, to scan the to FIG. 21, Profile Generation Instrumentation Table, and to update the corresponding entries in the FIG. 13, Store Profile Table.

Step 1206 sets up a loop based on Point-of-service Terminal ID 450. The loop looks at each Point-of-service Terminal ID 450 entry within the current store.

Step 1208 initializes a temporary variables: Total-Think-Time to Mean to Think Time 520*Number of Think Time Samples 524, and Sum-of-Squares-of-Think-Time=(Number of Think Time Samples 524−1)*(Std. Deviation of Think Time 522)ˆ 2+Mean Think Time 520ˆ 2; each time a new Point-of-service Terminal ID 450 is reached.

Step 1210 sets up a loop to process each pair of FIG. 18, Screen Instrumentation Message and FIG. 19, Customer Selection Instrumentation Message.

Step 1212 initializes a temporary variable: Think-Time=Time Stamp 388−Time Stamp 408, adds Think-Time TO Total-Think-Time, adds Think-Timeˆ 2 to Sum-of-Squares-of-Think-Time, and adds 1 to Number of Think Time Samples 524.

Step 1214 checks to see if the last pair of FIG. 18, Screen Instrumentation Message and FIG. 19, Customer Selection Instrumentation Message within Point-of-service Terminal ID 450 has been processed. If not control is returned to Step 1212 to process the next pair. Otherwise, control is passed to Step 1216.

Step 1216 checks to see if all the within Point-of-service Terminal IDs 450 within the Store ID 448 have been processed. If not control is returned to Step 1208 to process the next pair. Otherwise, control is passed to Step 1218.

Step 1218 then calculates Mean of Think Time 520=Total-Think-Time/Number of Think Time Samples 524, Std. Deviation of Think Time 522=((Sum-of-Squares-of-Think-Time−(Total-Think-Time)ˆ 2)/(Number of Think Time Samples 524−1))ˆ 0.5, adds 1 to Number of Idle Time Samples 536, Mean Idle Time 532=Total-of-Idle-Time/Number of Think Time Samples 524:

Step 1220 sets up a loop to calculate the Mean Idle Time statistics for FIG. 23, Store Profile Table. The loop control is done on Point-of-service Terminal ID 450.

Step 1222 sets up a loop to process each Session Number 452 in the Point-of-service Terminal IDs 450.

Step 1224 calculates temporary variables: Time-Min=MIN (Time 464 from current Session Number 452), Time-Max=MAX (Time 464 from current Session Number 452), Total-of-Idle-Time=Time-Max−Time-Min, and Sum-of-Squares-of-Idle-Time=(Time-Max−Time-Min)ˆ 2−1))ˆ 0.5. It then updates Mean Idle Time 532, Std. Deviation of Idle Time 534, and Number of Idle Time Samples 536 for the FIG. 23, Store Profile Table that corresponds to the first FIG. 21, Profile Generation Instrumentation Table for the current session.

Step 1226 checks for more Session Numbers 452 in FIG. 21, Profile Generation Instrumentation Table. If there are more, it sets up to process the next entry and transfers control to Step 1224, otherwise to Step 1228.

Step 1228 checks for more Point-of-service Terminal IDs 450 in FIG. 21, Profile Generation Instrumentation Table. If there are more, it sets up to process the next entry and transfers control to Step 1230, otherwise to Step 1222.

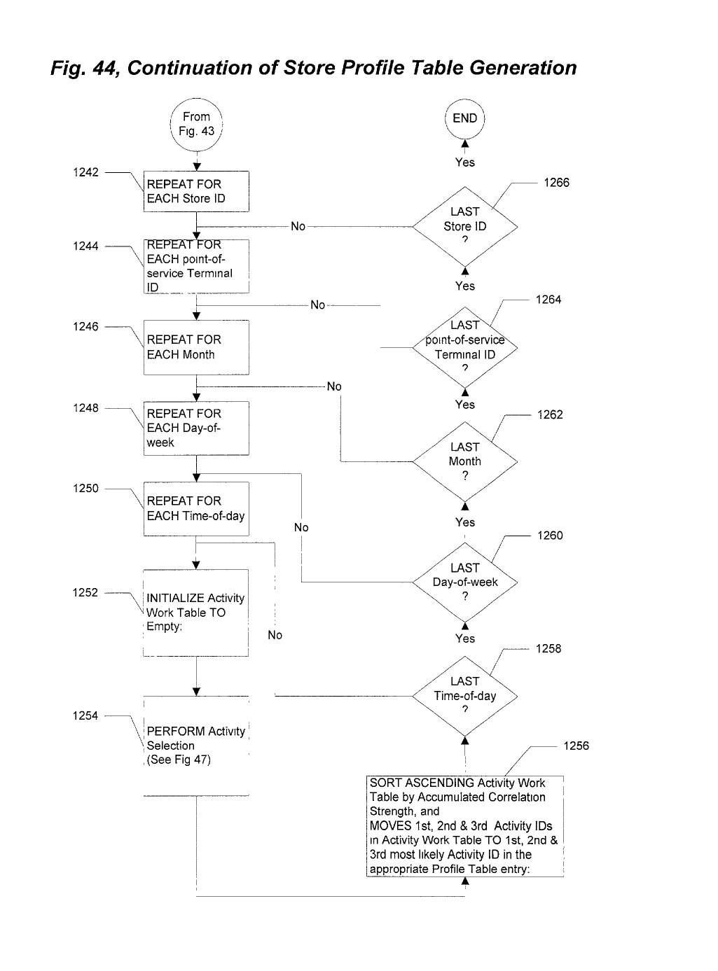

Step 1230 checks for more Store ID's 448 in FIG. 21, Profile Generation Instrumentation Table. If there are more it sets up to process the next entry and transfers control to FIG. 44, Step 1232, otherwise to Step 1206.

FIG. 44 is a Continuation of Store Profile Table Generation,

Step 1242 sets up a loop to process each Store ID 448 in FIG. 21, Profile Generation Instrumentation Table.

Step 1244 sets up a loop to process each Point-of-service Terminal 450 in FIG. 21, Profile Generation Instrumentation Table.

Step 1246 sets up a loop to process each Month 460 in FIG. 21, Profile Generation Instrumentation Table.

Step 1248 sets up a loop to process each Day-of-week 462 in FIG. 21, Profile Generation Instrumentation Table.

Step 1250 sets up a loop to process each Time-of-day 466 in FIG. 21, Profile Generation Instrumentation Table.

Step 1252 initializes FIG. 33, Activity Work Table to no entries and passes control to Step 1254, which calls FIG. 49, Activity Selection. Upon return, it passes control to Step 1256.

Step 1256 sorts the FIG. 33, Activity Work Table by Accumulated Correlation Strength 904, and then moves the Activity ID 902 from the first three entries in the FIG. 33, Activity Work Table into the FIG. 23, Store Profile Table's 1^{st} most likely Activity ID 538, 2^{nd} most likely Activity ID 540, and 3^{rd} most likely Activity ID 542. Control then passes to Step 1258.

Step 1258 checks for more Time-of-day 466 entries in FIG. 21, Profile Generation Instrumentation Table. If there are more it sets up to process the next entry and transfers control to Step 1252, otherwise control passes to Step 1260.

Step 1260 checks for more Day-of-week 462 entries in FIG. 21, Profile Generation Instrumentation Table. If there are more it sets up to process the next entry and transfers control to Step 1250, otherwise control passes to Step 1262.

Step 1262 checks for more Month 460 entries in FIG. 21, Profile Generation Instrumentation Table. If there are more it sets up to process the next entry and transfers control to Step 1248, otherwise control passes to Step 1264.

Step 1264 checks for more Point-of-service Terminal 450 entries in FIG. 21, Profile Generation Instrumentation Table. If there are more it sets up to process the next entry and transfers control to Step 1246, otherwise control passes to Step 1266.

Step 1266 checks for more Store ID 448 entries in FIG. 21, Profile Generation Instrumentation Table. If there are more it sets up to process the next entry and transfers control to Step 1244, otherwise the process ends.

FIG. 45, Customer Session Table Generation describes how the FIG. 24 Customer Session Table is constructed.

Step 1300 receives the FIG. 17, Store Controller Message, which is the trigger to build a FIG. 14, Customer Session Table entry.

Step 1302 checks Message ID 362 for ‘Start of Idle Time’ and passes control to Step 1304 if it is, otherwise to End.

Step 1304 sets Point-of-service Terminal ID 562 to Point-of-service Terminal ID 362, reads Customer ID 566 from FIG. 7, Customer Interface, sets Session Number 564=Next Session Number 914, and adds 1 to Next Session Number 914.

Step 1306 uses Customer ID 566, Current-Month, Current-Day, Current-Time-of-Day TO FIND FIG. 14, Store Subset—Customer Store Profile Table entry, or if the Customer ID 566 is anonymous, finds FIG. 23, Store Profile Table. From that entry setting: Expected Idle Time 570=Mean Idle Time 306 or 532, and moving 1st, 2nd and 3rd most likely Activity IDs 310, 312, and 314 or 538, 540 and 542 to the corresponding entries (572, 574, and 576) in the FIG. 14, Customer Session Table. It then ends the routine.

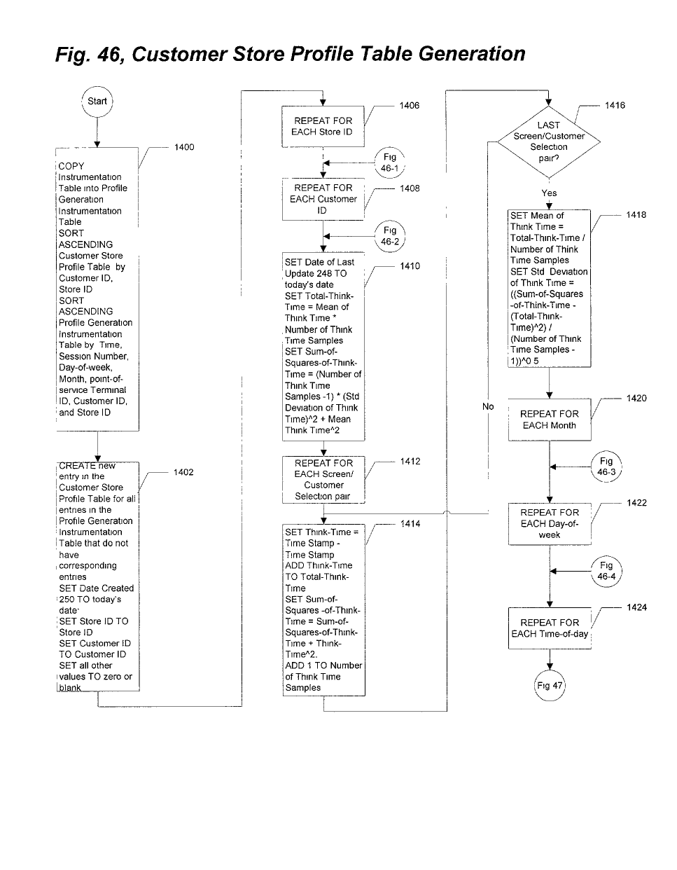

FIG. 46. Customer Store Profile Generation describes how the FIG. 13. Customer Store Profile Table is constructed.

Step 1400 copies FIG. 20 Instrumentation Table, into FIG. 21, Profile Generation Instrumentation Table; sorts Customer FIG. 13, Store Profile Table by: Customer ID 242, and Store ID 246 into ascending sequence; then continues sorting FIG. 21, Profile Generation Instrumentation Table by: Time 464, Session Number 452, Day-of-week 462, Month 460, Point-of-service Terminal ID 450, Customer ID 444, and Store ID 448.

Step 1402 creates a new entry in Customer FIG. 13, Store Profile Table for all entries in the FIG. 21, Profile Generation Instrumentation Table that do not have an entry in the Customer FIG. 13, Store Profile Table, setting Date Created 250 to today's date, sets Store ID 246 to Store ID 448, Customer ID 242 to Customer ID 444, and all other values to zero or blank:

Step 1406 sets up a loop to look at each Store ID 448 entry in FIG. 21, Profile Generation Instrumentation Table.

Step 1408 sets up a loop to look at each to Customer ID 444 entry in each Store ID 448.

Step 1410 sets Date of Last Update 248 to today's date, temporary variables: Total-Think-Time=Mean of Think Time 252*Number of Think Time Samples 256, and Sum-of-Squares-of-Think-Time=(Number of Think Time Samples 256−1)*(Std. Deviation of Think Time 254)ˆ 2+Mean Think Time 252ˆ 2.

Step 1412 sets up a loop to look at each FIG. 18, Screen Instrumentation Message, FIG. 19, Customer Selection Instrumentation Message pair in FIG. 21, Profile Generation Instrumentation Table for Customer ID 444.

Step 1414 sets temporary variable Think-Time to Time Stamp 408−Time Stamp 388, adding Think-Time to Total-Think-Time, Sum-of-Squares-of-Think-Time to Sum-of-Squares-of-Think-Time+Think-Timeˆ 2, and adding 1 to Number of Think Time Samples 256.

Step 1416 check to see if all pairs have been processed. If not, control is passed to Step 1414, other wise to Step 1418.

Step 1418 sets Mean of Think Time 252 to Total-Think-Time/Number of Think Time Samples 256, sets Std. Deviation of Think Time 254=((Sum-of-Squares-of-Think-Time−(Total-Think-Time)ˆ 2)/(Number of Think Time Samples 256−1))ˆ 0.5:

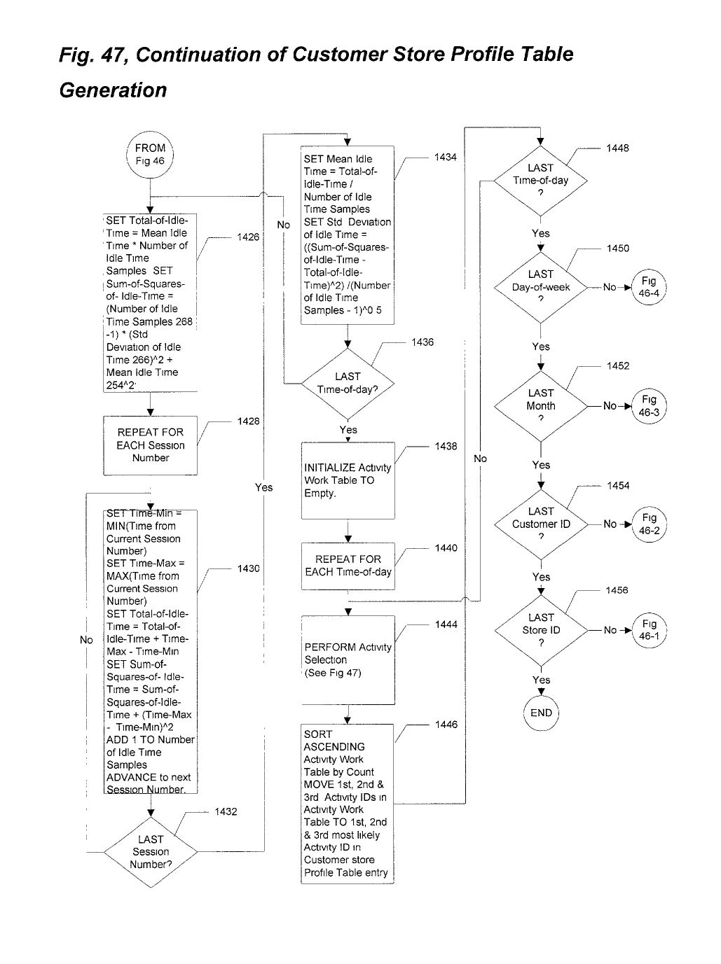

Steps 1420, 1422 and 1424 set up nested loops for Time-of-Day, Day-of-Week, and Month. These loop variables determine which fields in FIG. 13, Customer Store Profile Table are used with the loops. Control passes to FIG. 47, Step 1426.

FIG. 47 is a continuation of FIG. 46, Customer Store Profile Generation.

Step 1426 sets Total-of-Idle-Time=Mean Idle Time 264*Number of Idle Time Samples 268, Sum-of-Squares-of-Idle-Time=(Number of Idle Time Samples 268−1)*(Std. Deviation of Idle Time 266)ˆ 2+Mean Idle Time 254ˆ 2. Step 1428 set up a loop for each Session Number 452 within the Time-of-day inverval.

Step 1430 sets temporary variables: Time-Min=MIN(Time 464 from current Session Number 452 within FIG. 21, Profile Generation Instrumentation Table), Time-Max=MAX(Time 464 from current Session Number 452 within FIG. 21, Profile Generation Instrumentation Table), Total-of-Idle-Time=Total-of-Idle-Time+Time-Max−Time-Min, Sum-of-Squares-of-Idle-Time=Sum-of-Squares-of-Idle-Time+(Time-Max−Time-Min)ˆ 2, and adds 1 to Number of Idle Time Samples. It then sets up to process the next session number in FIG. 21, Profile Generation Instrumentation Table.

Step 1432 checks to see if all the session numbers in the FIG. 21, Profile Generation Instrumentation Table have been processed. If not control passes back to Step 1430; otherwise, control passes to Step 1434.

Step 1434 sets Mean Idle Time 264=Total-of-Idle-Time/Number of Idle Time Samples 268, Std. Deviation of Idle Time 266=((Sum-of-Squares-of-Idle-Time−Total-of-Idle-Time)ˆ 2)/(Number of Idle Time Samples 268−1)ˆ 0.5.

Step 1436 checks to see if all the Time-of-day intervals in the FIG. 21, Profile Generation Instrumentation Table have been processed for the current Day-of-week interval. If not control passes back to Step 1426; otherwise, control passes to Step 1438.

Step 1438 initializes Activity Work Table to Empty, and sets temporary variable Last-Activity-ID TO null.

Step 1440 set up a loop for each Time-of-day within Day.

Step 1444 calls FIG. 49, Activity Selection. Upon return from FIG. 49, Activity Selection control Passes to Step 1446.

Step 1446 sorts FIG. 33, Activity Work Table in ascending sequence by Accumulated Correlation Strength 904, moves 1st, 2nd & 3rd elements' Activity IDs 902 from FIG. 33, Activity Work Table to 1st, 2nd & 3rd most likely Activity ID 270, 272, & 274; in Customer FIG. 13, Store Profile Table entry, passing control to Step 1448.

Step 1448 checks to see if the last Time-of-day 446 In FIG. 21, Profile Generation Instrumentation Table has been processed. If not, control passes to Step 1444; otherwise, control passes to Step 1450.

Step 1450 checks to see if the last Day-of-week 462 In FIG. 21, Profile Generation Instrumentation Table has been processed. If not, control passes to FIG. 45A-4. Step 1424, otherwise control passes to Step 1452.

Step 1452 checks to see if the last Month 460 in FIG. 21, Profile Generation Instrumentation Table has been processed. If not, control passes to FIG. 45A-3. Step 1422, otherwise control passes to Step 1454.

Step 1454 checks to see if the last Customer ID 444 in FIG. 21, Profile Generation Instrumentation Table has been processed. If not, control passes to FIG. 46-2. Step 1410), otherwise, control passes to Step 1456.

Step 1456 checks to see if the last Store ID 448 in FIG. 21, Profile Generation Instrumentation Table has been processed. If not, control passes to FIG. 45A-1. Step 1408, otherwise the routine ends.

FIG. 48, System Response Time Calculation describes how System Response Time is calculated. This routine is a never-ending loop.

Step 1500 read either FIG. 18, Screen Instrumentation Message or FIG. 19, Customer Selection Instrumentation Message from the FIG. 7, Customer Interface and inserts it in FIG. 20, Instrumentation Table. Step 1500 throttles the loop by the read operation, which causes the routine to wait if there are no messages.

Step 1502 checks to see if Record Type Flag 442 in FIG. 21, Profile Generation Instrumentation Table is equal to ‘Customer Selection’. If not, control passes to Step 1506; otherwise, control passes to Step 1504.

Step 1504 sets FIG. 35, Time of Last Customer Selection Instrumentation Signal to Time 432, using Point-of-service Terminal ID 450 to select the corresponding entry in FIG. 35, System Response Time Work Table. It passes control to Step 1500.

Step 1506 checks to see if Record Type Flag 442 in FIG. 21, Profile Generation Instrumentation Table is equal to ‘Screen Selection’. If not, control passes to Step 1508; otherwise, control passes to Step 1508.

Step 1508 sets Time of Last Screen Instrumentation Signal USING Point-of-service Terminal ID 420 TO select entry in FIG. 35, System Response Time Work Table. Then adds 1 to Number of Samples 938, setting temporary variable Response-Time=Time of Last Screen Instrumentation Signal 936−Time of Last Customer Response Instrumentation Signal 934, adding Response-Time to Total of Response Time 940, adding Response-Timeˆ 2 TO Sum of Square of Response Times 942, and passes control to Step 1500.

FIG. 49 is a flow chart of Activity Selection that describes how the 1^{st} most likely Activity ID 270, 2^{nd} most likely Activity ID 272, 3^{rd} most likely Activity ID 274, 1^{st} most likely Activity ID 538, 2^{nd} most likely Activity ID 540, and 3^{rd} most likely Activity ID 542 are assigned.

Step 1702 saves the state of FIG. 21, Profile Generation Instrumentation Table, passes control to Step 1704, which initializes a loop to process each entry in FIG. 21, Profile Generation Instrumentation Table, and passes control to 1706.

Step 1706 looks at each entry in FIG. 21, Profile Generation Instrumentation Table and deletes those that did not conform to the Store ID 448, Customer ID 444, Month, Day-of-week, and Time-of-day being processed. Then Step 1708 check to see if all entries have been processed. If not, the loop is set up for the next entry and control passes to Step 1706. Otherwise, control passes to Step 1710.

Step 1710 initializes a loop to process each entry in FIG. 21, Profile Generation Instrumentation Table and passes control to 1712.

Step 1712 initializes a loop to process each entry in FIG. 49, Purchase and Activity Correlation Table and passes control to 1714, which checks to see if Product Code 1704 and Product Code 468 in the current entries match. If so control passes to Step 1716. Otherwise, control passes to Step 1718.

Step 1716 finds if an entry for Activity 1022 with Activity ID 1702 exist in FIG. 33, Activity Work Table and if not, it creates an entry initializing Activity ID 902 to Activity ID 1702 and setting Accumulated Correlation Strength 904 to zero. In either case, Strength of Correlation 1706 is added to Accumulated Correlation Strength 904. Control then passes to Step 1718 which checks to see if the last FIG. 49, Purchase and Activity Correlation Table entry has been processed. If not control passes to Step 1714 to process the next entry. Otherwise, control passes to Step 1720 which checks to see if the last FIG. 21, Profile Generation Instrumentation Table entry has been processed. If not control passes to Step 1712 to process the next entry. Otherwise control passes to Step 1722 which sorts the FIG. 33, Activity Work Table in to ascending order by Accumulated Correlation Strength 904 and passes control to Step 1724.

Step 1724 rebuilds the FIG. 21, Profile Generation Instrumentation Table from the state saved in Step 1702 and returns to the calling program.

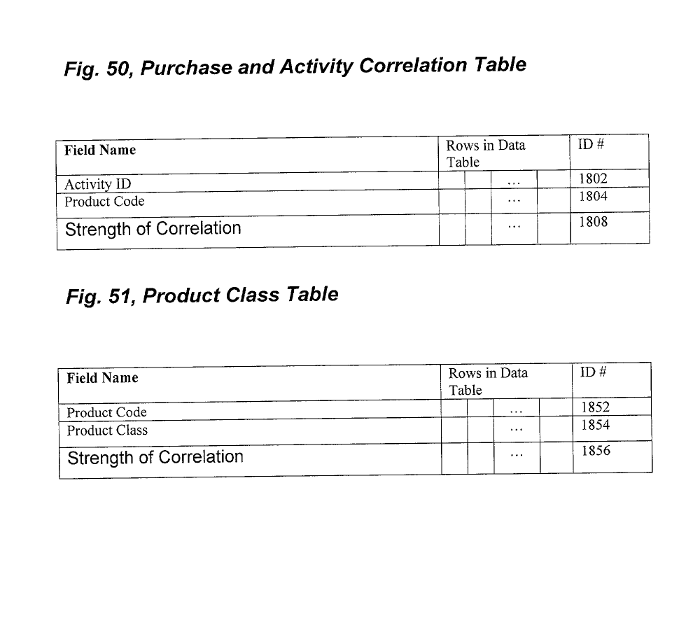

FIG. 50 is a Purchase and Activity Correlation Table that contains a Activity ID 1802 which is the ID of an Activity 1022 that can be presented to a customer. Product Code 1804 is a code assigned to products sold in the various venues. It is described in the form of the standard Uniform Product Code, but may be any code for identifying products. Product Code 1804 could represent a product class as describe in Product Class Table 1850, as well as individual products. Product Class 1806 indicates the class of products for this product. Strength of Correlation 1808 describes the likelihood that a customer purchasing the product specified by Product Code 1804 will be interested in the Activity 1022 specified by Activity ID 1702. The value in Strength of Correlation 1808, ranges from −1 to +1.

FIG. 51 is a Product Class Table 1850 that contains a Product Code 1852 and Product Class 1854, which the product specified by Product Code 1852, is a member. The degree of membership is indicated by Strength of Correlation 1856. The value in Strength of Correlation 1856 ranges from 0 to +1.

Typical Hardware and Software Infrastructure

This invention is based on conventional point-of-service systems. Many manufacturers supply point-of-service equipment, and the invention is not limited to any particular manufacture's equipment. The invention can be implemented using IBM's 3680 Programmable Store System. The FIG. 4, Store Controller being an IBM 3650 and the FIG. 6, Point-of-service Terminal being IBM 3683s.

IBM supplies software (IBM programmable store system MICRCODE) used in controlling operations in the hardware described and a program product (Subsystem Program Preparation Support II (SPPS II)) for writing controller and terminal programs. SPPS II includes languages, macroinstructions, and a terminal display language. Communication between the terminals and the store controller is done by using a LAN 71 and a program written in IBM 3650 Programmable Store System Microcode. Other application programs that form the infrastructure for the invention are SDM (Store Data Management) and HCP (Host Communication Program), both sold by IBM.

It should be understood that the foregoing description is only illustrative of the invention. Various alternatives and modifications can be devised by those skilled in the art without departing from the invention. Accordingly, the present invention is intended to embrace all such alternatives, modifications, and variances, which fall within the scope of the appended claims.

What is claimed is:

1. A system for presenting one or more activities to a user at a computer terminal based on the prior purchasing history of said user, the system comprising:
at least one terminal at a user location including means for presenting information to the user and for receiving responses from the user;
a server with which the terminal can communicate, the server having a user database, and an activity database;
said user database having a user identification means, a purchased products identification means, and a user profile means;
said user identification means being capable of associating unique individuals with said user profile means;
said user profile means containing a preferred activity identification means;
said activity database having means to identify and define activities;
said activity database having a means to associate said activities with a product identification means;
means for associating the user with one or more said activities where said association is based on said purchased products identification means;
means for collecting historical information about the user's usage of said system; and
means for selecting and ordering one or more of said associated activities for presentation to said user, based on said prior purchase.

2. A system as recited in claim 1, wherein the means for selecting and ordering one or more of said associated activities for presentation to said user, based on said prior purchase, further includes means for estimating the likelihood that said activity will be selected by the user.

3. A system as recited in claim 1, wherein the said historical information having means to produce said user profile.

4. A system as recited in claim 1, wherein the said user identification means being capable of associating anonymous individuals with said user profile means.

5. A system as recited in claim 1, wherein the means for selecting said activity for presentation, makes use of historically experienced user purchases for a population of users to estimate said likelihood that said activity will be selected by the user.

6. A system as recited in claim 1, wherein the means selecting said activity for presentation makes use of historically experienced user purchases for a population of users in similar venues to a venue of said user location.

7. A system as recited in claim 1, wherein the means selecting said activity for presentation makes use of historically experienced user purchases for a population of users in a same venue as a venue of said user location.

8. A system as recited in claim 1, wherein said presentations comprise offerings of products or services to said user.

9. A system as recited in claim 1, wherein said purchased product identification means having a product class identification means, and said means for associating the user with one or more said activities where said association is based on said products class identification means.

10. A memory media for operating a server to control a system to select activities presented to a user, the system comprising at least one terminal at a user location which includes means for presenting information to the user and for receiving responses from the user, said server having a user database and an activity database, said user database having a user identification data and user profile data, said activity database including means for identifying and defining activities, said memory media comprising:
a) means for controlling said server to employ said user database to associate the user with one or more activities;
b) means for controlling said server to select said activities for presentation to said user based on the probability that said activities will be selected by said user; and
c) means for controlling said server to present said presentation dialogues to said user via said at least one terminal and to receive responses from said user.

11. The memory media as recited in claim 10, wherein means b) makes use of historically experienced user purchases for a population of users in similar venues to a venue of said user checkout location.

12. The memory media as recited in claim 10, wherein means b) makes use of historically experienced user purchases for a population of users in a same venue as a venue of said user checkout location.

13. The memory media as recited in claim 10, wherein the presentation dialogues comprise offerings of products or services to said user.

14. The memory media as recited in claim 10, wherein said user identification data includes means to identify anonymous users, said user profile means includes means to store anonymous user profiles, and said means for controlling said server to select said activities includes means to associate said identified anonymous users with said anonymous user profiles.

15. The memory media as recited in claim 10, wherein said purchased product identification means includes means to identify a product class identification, and said means for associating the user with one or more said activities where said association is based on said products class identification means.
